(19) United States
(12) Patent Application Publication
(10) Pub. No.: US 2025/0205759 A1
(43) Pub. Date: Jun. 26, 2025

(54) Drain Cleaning Device

(71) Applicants: Stephen S. Turner, Edelstein, IL (US); Scott I. Turner, Chillicothe, IL (US)

(72) Inventors: Stephen S. Turner, Edelstein, IL (US); Scott I. Turner, Chillicothe, IL (US)

(21) Appl. No.: 19/063,186

(22) Filed: Feb. 25, 2025

Related U.S. Application Data
(63) Continuation-in-part of application No. 17/970,493, filed on Oct. 20, 2022.
(63) Continuation-in-part of application No. 17/881,537, filed on Aug. 4, 2022.
(60) Provisional application No. 63/257,915, filed on Oct. 20, 2021.
(60) Provisional application No. 63/316,995, filed on Mar. 5, 2022.
(60) Provisional application No. 63/229,465, filed on Aug. 4, 2021.
(60) Provisional application No. 63/257,915, filed on Oct. 20, 2021.
(60) Provisional application No. 63/740,907, filed on Dec. 31, 2024.

(51) Int. Cl. B08B 9/045

(52) U.S. Cl. CPC B08B 9/045

(57) ABSTRACT

A drain cleaning device for removing debris from a drain is disclosed herein. The drain cleaning device includes an elongated shaft section having a first end, a second end, and a shaft axis, the first end of the elongated shaft section being oppositely disposed relative to the second end of the elongated shaft section; and a tip section connected to the second end of the elongated shaft section, the tip section including a central core portion and a plurality of protruding elements extending from the central core portion, the plurality of protruding elements being disposed at least partially around a periphery of the central core portion. The first end of the elongated shaft section is configured to be coupled to a rotary motion input device that is sufficient to rotate the plurality of protruding elements of the tip section about the shaft axis.

### CROSS-REFERENCE TO RELATED APPLICATIONS

This patent application is a continuation-in-part of U.S. Nonprovisional patent application Ser. No. 17/970,493, entitled “Power Tool Adapter For A Drain Cleaning Device”, filed on Oct. 20, 2022, which claims priority to U.S. Provisional Patent Application No. 63/257,915, entitled “Power Tool Adapter For A Drain Cleaning Device”, filed on Oct. 20, 2021, and U.S. Provisional Patent Application No. 63/316,995, entitled “Pipe Cleaning Device”, filed on Mar. 5, 2022, all of the disclosures of which are herein expressly incorporated by reference in their entireties.

This patent application also is a continuation-in-part of U.S. Nonprovisional patent application Ser. No. 17/881,537, entitled “Cleaning Device For Removing Hair And/Or Debris From A Rotary Brush And A Method Using The Same”, filed on Aug. 4, 2022, which claims priority to U.S. Provisional Patent Application No. 63/229,465, entitled “Cleaning Device For Removing Hair And/Or Debris From A Rotary Brush And A Method Using The Same”, filed on Aug. 4, 2021, and U.S. Provisional Patent Application No. 63/257,915, entitled “Power Tool Adapter For A Drain Cleaning Device”, filed on Oct. 20, 2021, all of the disclosures of which are herein expressly incorporated by reference in their entireties.

This patent application also claims priority to, and incorporates by reference in its entirety, U.S. Provisional Patent Application No. 63/740,907, entitled “Drain Cleaning Device”, filed on Dec. 31, 2024.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION BY REFERENCE OF MATERIAL SUBMITTED ON A COMPACT DISK

Not Applicable.

### BACKGROUND OF THE INVENTION

### 1. Field of the Invention

The invention generally relates to a drain cleaning device. More particularly, the invention relates to a drain cleaning device used for cleaning drains by removing hair and other debris that is collected in the upper portion of the drain where stopper or strainer mechanisms and other obstructions occur or collected anywhere along the drain pipe down to the bottom elbow bends of the drain where hair and other debris has collected (e.g., in the drain trap).

### 2. Background

Bathroom drains are clogged most often by hair that enters the drain and collects from the drain trap at the bottom up to the drain opening. Most frequently, the hair combines with sticky products such as soap, shampoo, and toothpaste and builds a “log-jam” of sorts where these drain obstructions catch the hair, and some settles in the drain trap. After sufficient amounts of hair have collected in the drain trap or around the upper opening, the water from the sink basin begins to drain noticeably more slowly, and eventually can completely block the water from draining. Drain chemicals, home remedies such as baking soda and vinegar and plungers are frequently used for these clogs, but often fail to dissolve or dislodge the hair clogging the drain. In extreme cases, the only remaining remedy is to disassemble the drain or use a device that can effectively reach, snag, and extract the hair (e.g., a drain snake).

Also, liquid or gel-based chemical drain unclogging agents can contain corrosive chemicals that may damage the drain structure. The drain cleaning chemicals may also cause health problems to those who handle the liquids or gels incorrectly. Another problem with chemical agents is that a significant portion of the chemical agent may flow past the hair-clog (for example, in the vertical portion of a bathroom sink drain) such that the chemical cannot effectively submerge the hair in order to completely dissolve it.

In addition, because the hair and other debris may be tightly twisted around the drain structure, it may be difficult to remove this hair and debris manually using a drain snake. The manual removal of this hair and other debris may be particularly difficult for a user that is elderly or disabled.

Therefore, what is needed is a drain cleaning device that enables a user to interchangeably utilize a power tool or a manual handle to clear sink and tub drain clogs.

### BRIEF SUMMARY OF EMBODIMENTS OF THE INVENTION

Accordingly, the present invention is directed to a drain cleaning device that substantially obviates one or more problems resulting from the limitations and deficiencies of the related art.

In accordance with one or more embodiments of the present invention, there is provided a drain cleaning device for removing debris from a drain. The drain cleaning device includes an elongated shaft section having a first end, a second end, and a shaft axis, the first end of the elongated shaft section being oppositely disposed relative to the second end of the elongated shaft section; and a tip section connected to the second end of the elongated shaft section, the tip section including a central core portion and a plurality of protruding elements extending from the central core portion, the plurality of protruding elements being disposed at least partially around a periphery of the central core portion. In these one or more embodiments, the first end of the elongated shaft section is configured to be coupled to a rotary motion input device that is sufficient to rotate the plurality of protruding elements of the tip section about the shaft axis; and whereby, upon the elongated shaft section being rotated by the rotary motion input device, the plurality of protruding elements are configured to grab and collect debris from a drain pipe.

In a further embodiment of the present invention, the rotary motion input device for rotating the elongated shaft section is selected from the group consisting of: (i) a drill, (ii) a screwdriver, (iii) a power drill, (iv) a power screwdriver, and (v) a detachable handle section.

In yet a further embodiment, the tip section further comprises an outer covering formed from a hook material strip that is bonded to the central core portion of the tip section that extends from the elongated shaft section, the hook material strip comprising the plurality of protruding elements of the tip section, and the hook material strip being made from a hook side of a hook-and-loop fastener material.

In still a further embodiment, the elongated shaft section is formed from a semi-flexible cable, the semi-flexible cable comprising a plurality of bundled wires, the hook material strip being bonded to an outer surface of the semi-flexible cable.

In yet a further embodiment, the elongated shaft section comprises a plastic shaft.

In still a further embodiment, the drain cleaning device further comprises a power tool adapter configured to couple the first end of the elongated shaft section to the rotary motion input device, the power tool adapter includes an adapter body with a shank section for being inserted into a recess of the rotary motion input device.

In yet a further embodiment, the shank section of the power tool adapter has a generally hexagonal or round cross-sectional shape.

In still a further embodiment, the shank section of the power tool adapter has an annular recess formed in the shank section.

In yet a further embodiment, the rotary motion input device is in a form of a detachable handle section configured to be detachably coupled to the elongated shaft section of the drain cleaning device.

In still a further embodiment, the detachable handle section has a proximal end portion and a distal end portion, the distal end portion of the detachable handle section being configured to be detachably coupled to a proximal end portion of the elongated shaft section of the drain cleaning device.

In yet a further embodiment, the drain cleaning device further comprises a sleeve member that is slidable along a length of the detachable handle section between (i) a disengaged position where the elongated shaft section of the drain cleaning device is able to be released from the detachable handle section, and (ii) an engaged position where the distal end portion of the detachable handle section is locked into engagement with the proximal end portion of the elongated shaft section of the drain cleaning device.

In still a further embodiment, in the engaged position of the sleeve member, the sleeve member is rotatably disposed about the detachable handle section, the sleeve member configured to be grasped by a hand of a user during the spinning of the drain cleaning device by the user so as to help stabilize the drain cleaning device, the drain cleaning device being configured to be rotated relative to the sleeve member while the sleeve member is held stationary by the hand of the user.

In yet a further embodiment, the detachable handle section comprises an upper handle portion and a lower handle portion, the upper handle portion being spaced apart from the lower handle portion along a length of the drain cleaning device, the upper handle portion configured to accommodate a first hand of a user during a spinning of the drain cleaning device by the user, and the lower handle portion configured to accommodate a second hand of the user during the spinning of the drain cleaning device by the user.

In still a further embodiment, the detachable handle section further comprises a transverse handle portion connecting the upper handle portion to the lower handle portion.

In yet a further embodiment, at least one section of the upper handle portion or the lower handle portion has a generally circular cross-section.

It is to be understood that the foregoing general description and the following detailed description of the present invention are merely exemplary and explanatory in nature. As such, the foregoing general description and the following detailed description of the invention should not be construed to limit the scope of the appended claims in any sense.

### BRIEF DESCRIPTION OF THE SEVERAL VIEWS OF THE DRAWINGS

The invention will now be described, by way of example, with reference to the accompanying drawings, in which:

FIG. 1 is a perspective view of a drain cleaning assembly, according to an illustrative embodiment of the invention, wherein the drain cleaning assembly includes a power tool adapter and a first type of drain cleaning device;

FIG. 2 is a first side elevational view of the drain cleaning assembly of FIG. 1;

FIG. 3 is a second side elevational view of the drain cleaning assembly of FIG. 1;

FIG. 4 is a rear elevational view of the drain cleaning assembly of FIG. 1;

FIG. 5 is a front elevational view of the drain cleaning assembly of FIG. 1;

FIG. 6 is a first end view of the drain cleaning assembly of FIG. 1;

FIG. 7 is a second end view of the drain cleaning assembly of FIG. 1;

FIG. 8A is a side view illustrating the manner in which the power tool adapter is inserted into a drill;

FIG. 8B is another side view illustrating the manner in which the sleeve member of the power tool adapter is moved into a disengaged position;

FIG. 8C is yet another side view illustrating the manner in which the drain cleaning device is engaged with the power tool adapter;

FIG. 8D is still another side view illustrating the manner in which the sleeve member of the power tool adapter is moved into a engaged position so as to lock the drain cleaning device into engagement with the power tool adapter;

FIG. 9 is a perspective view illustrating the manner in which the drain cleaning assembly of FIG. 1 may be used to clean a drain pipe of a sink drain;

FIG. 10 is a longitudinal sectional view cut through the distal end portion of the power tool adapter and the proximal end portion of the drain cleaning device so as to illustrate the engagement between the power tool adapter and the drain cleaning device, wherein the section is generally cut along the cutting-plane line A-A in FIG. 5;

FIG. 11 is an exploded perspective view of the drain cleaning assembly of FIG. 1;

FIG. 12 is an enlarged perspective view of the distal end portion of the power tool adapter and the proximal end portion of the drain cleaning device (Detail “A” from FIG. 11), wherein the drain cleaning device is shown detached from the power tool adapter;

FIG. 13 is another enlarged perspective view of the distal end portion of the power tool adapter and the proximal end portion of the drain cleaning device, wherein the drain cleaning device is shown detached from the power tool adapter, similar to FIG. 12;

FIG. 14 is an enlarged exploded perspective view of the power tool adapter and the proximal end portion of the drain cleaning device;

FIG. 15 is a perspective view of a drain cleaning assembly, according to another illustrative embodiment of the invention, wherein the drain cleaning assembly includes a power tool adapter and a second type of drain cleaning device;

FIG. 16 is a front elevational view of the drain cleaning assembly of FIG. 15;

FIG. 17 is a rear elevational view of the drain cleaning assembly of FIG. 15;

FIG. 18 is an exploded partial perspective view of the drain cleaning assembly of

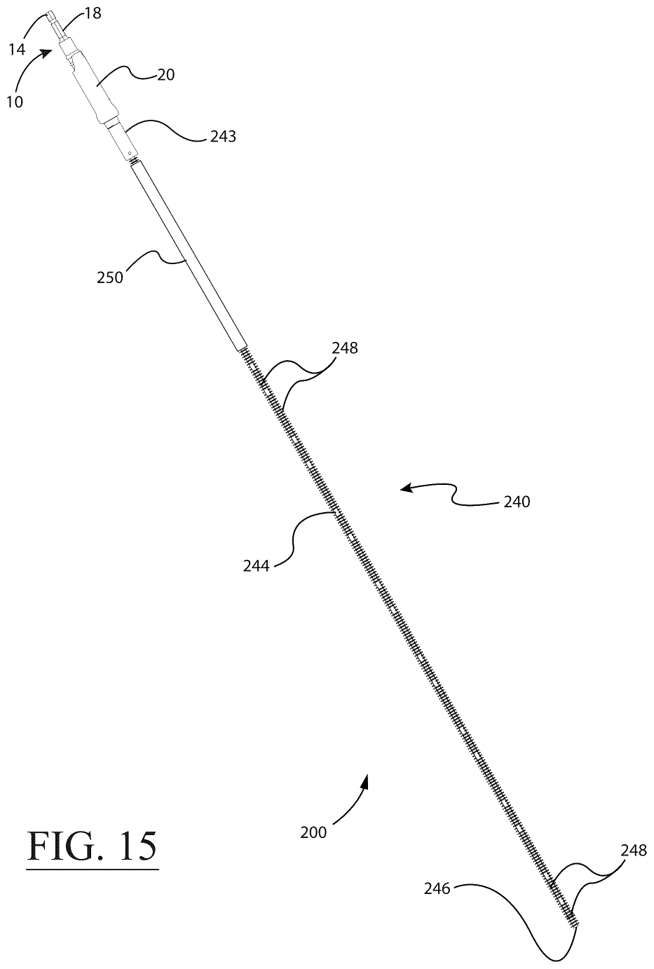

FIG. 15, wherein a handle member that is interchangeable with the power tool adapter is further illustrated;

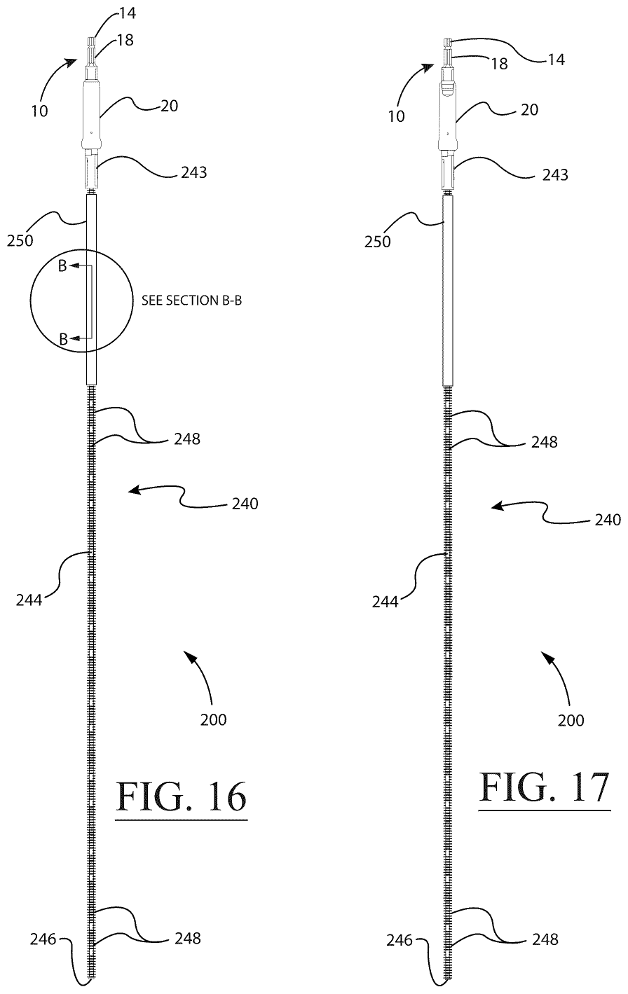

FIG. 19 is a longitudinal sectional view cut through an elongated rod section and elongated sleeve member of the drain cleaning device of FIG. 15, wherein the section is generally cut along the cutting-plane line B-B in FIG. 16;

FIG. 20 is a perspective view of a cleaning device mounted on a drill, according to an illustrative embodiment of the invention, the cleaning device configured to remove hair and/or debris from a rotary brush when rotated by the drill;

FIG. 21 is another perspective view of the cleaning device of FIG. 20 mounted on the drill, the cleaning device contains hair and/or debris thereon after being used to clean a rotary brush, and additional cleaning devices are illustrated next to the drill;

FIG. 22 is a perspective view of the cleaning device of FIG. 20;

FIG. 23 is a perspective view of a first exemplary central core portion of the cleaning device of FIG. 20;

FIG. 24 is an end view of the cleaning device of FIG. 20 illustrating the outer covering of the cleaning device bonded to the first exemplary central core portion;

FIG. 25 illustrates a first exemplary wire configuration for the central core portion of the cleaning device of FIG. 20;

FIG. 26 illustrates a second exemplary wire configuration for the central core portion of the cleaning device of FIG. 20;

FIG. 27 is an end view depicting a cleaning device having a second exemplary central core portion, according to another illustrative embodiment of the invention;

FIG. 28 illustrates different types of central core portions that may be used in the cleaning device of FIG. 27;

FIG. 29 is an end view of the cleaning device of FIG. 27 which illustrates the end of the cleaning device being terminated by dipping the end in glue or plastic;

FIG. 30 is an end view of the cleaning device of FIG. 20 which illustrates the end of the cleaning device being terminated by soldering the wires of the central core portion;

FIG. 31 is a first perspective view of the cleaning device and drill of FIG. 20 being used to clean the rotary brush of a vacuum cleaner;

FIG. 32 is a second perspective view of the cleaning device and drill of FIG. 20 being used to clean the rotary brush of a vacuum cleaner;

FIG. 33 is a perspective view of a cleaning device mounted on a first type of manual handle assembly, according to another illustrative embodiment of the invention, the cleaning device configured to remove hair and/or debris from a rotary brush when a user rotates the handle of the manual handle assembly;

FIG. 34 is a side view of the cleaning device mounted on the manual handle assembly of FIG. 33;

FIG. 35 is a perspective view of the handle collet subassembly of the manual handle assembly of FIG. 33;

FIG. 36 is a side view of the handle collet subassembly of the manual handle assembly of FIG. 33;

FIG. 37 is a perspective view of the sleeve of the manual handle assembly of FIG. 33;

FIG. 38 is a side view of the sleeve of the manual handle assembly of FIG. 33;

FIG. 39 is a perspective view of the mandrel of the manual handle assembly of FIG. 33;

FIG. 40 is a side view of the mandrel of the manual handle assembly of FIG. 33;

FIG. 41 is an end view of the mandrel of the manual handle assembly of FIG. 33;

FIG. 42 is a perspective view of a cleaning device that includes a power tool adapter, according to yet another illustrative embodiment of the invention, the cleaning device configured to remove hair and/or debris from a rotary brush when rotated by a power tool;

FIG. 43 is a rear elevational view of the cleaning device with the power tool adapter of FIG. 42;

FIG. 44 is a first side elevational view of the cleaning device with the power tool adapter of FIG. 42;

FIG. 45 is a second side elevational view of the cleaning device with the power tool adapter of FIG. 42;

FIG. 46 is a top plan view of the cleaning device with the power tool adapter of FIG. 42;

FIG. 47 is a bottom plan view of the cleaning device with the power tool adapter of FIG. 42;

FIG. 48 is a front elevational view of the cleaning device with the power tool adapter of FIG. 42;

FIG. 49 is a longitudinal sectional view cut through the cleaning device and the power tool adapter of FIG. 42, wherein the section is generally cut along the cutting-plane line C-C in FIG. 43;

FIG. 50 is an exploded perspective view of the cleaning device and the power tool adapter of FIG. 42;

FIG. 51 is a perspective view of a cleaning device mounted on a second type of manual handle assembly, according to still another illustrative embodiment of the invention, the cleaning device configured to remove hair and/or debris from a rotary brush when a user rotates the handle of the manual handle assembly;

FIG. 52 is a rear elevational view of the cleaning device mounted on the manual handle assembly of FIG. 51;

FIG. 53 is a first side elevational view of the cleaning device mounted on the manual handle assembly of FIG. 51;

FIG. 54 is a second side elevational view of the cleaning device mounted on the manual handle assembly of FIG. 51;

FIG. 55 is a top plan view of the cleaning device mounted on the manual handle assembly of FIG. 51;

FIG. 56 is a bottom plan view of the cleaning device mounted on the manual handle assembly of FIG. 51;

FIG. 57 is a front elevational view of the cleaning device mounted on the manual handle assembly of FIG. 51;

FIG. 58 is a longitudinal sectional view cut through the cleaning device and the manual handle assembly of FIG. 51, wherein the section is generally cut along the cutting-plane line D-D in FIG. 52;

FIG. 59 is an exploded perspective view of the cleaning device and the manual handle assembly of FIG. 51;

FIG. 60A is a perspective view of a drain cleaning device, according to yet another illustrative embodiment of the invention, wherein the elongated shaft of the drain cleaning device is formed from a cable;

FIG. 60B is an enlarged broken perspective view of the drain cleaning device of FIG. 60A depicting details of the first and second ends of the drain cleaning device;

FIG. 61 is a front elevational view of the drain cleaning device of FIG. 60A;

FIG. 62 is a rear elevational view of the drain cleaning device of FIG. 60A;

FIG. 63 is a first side elevational view of the drain cleaning device of FIG. 60A;

FIG. 64 is a second side elevational view of the drain cleaning device of FIG. 60A;

FIG. 65 is a first end view of the drain cleaning device of FIG. 60A;

FIG. 66 is a second end view of the drain cleaning device of FIG. 60A;

FIG. 67 illustrates an exemplary wire configuration for the elongated shaft of the drain cleaning device of FIG. 60A, wherein the section is generally cut along the cutting-plane line E-E in FIG. 60B;

FIG. 68 is an enlarged perspective view of the distal end portion of the drain cleaning device (Detail “B” from FIG. 60B);

FIG. 69 is a perspective view illustrating the manner in which the drain cleaning device of FIG. 60A may be used to clean a drain pipe of a sink drain;

FIG. 70A is a perspective view of a drain cleaning device, according to still another illustrative embodiment of the invention, wherein the drain cleaning device has a plastic elongated shaft and the drain cleaning device is provided with a detachable handle section;

FIG. 70B is an enlarged broken perspective view of the drain cleaning device of FIG. 70A depicting details of the detachable handle section and the first and second ends of the elongated shaft of the drain cleaning device;

FIG. 71 is a bottom plan view of the detachable handle section of the drain cleaning device of FIG. 70A;

FIG. 72 is a top plan view of the detachable handle section of the drain cleaning device of FIG. 70A;

FIG. 73 is a side elevational view of the detachable handle section of the drain cleaning device of FIG. 70A;

FIG. 74 is an exploded partial perspective view of the drain cleaning device of FIG. 70A;

FIG. 75 is an enlarged partial perspective view of the drain cleaning device of FIG. 70A depicting the insertion of the elongated shaft into the detachable handle section, wherein the sleeve is in the disengaged position;

FIG. 76 is another enlarged partial perspective view of the drain cleaning device of FIG. 70A depicting the sleeve of the detachable handle section in the engaged position securing the elongated shaft into the detachable handle section;

FIG. 77 is a longitudinal sectional view cut through the distal end portion of the detachable handle section and the proximal end portion of the drain cleaning device so as to illustrate the engagement between the detachable handle section and the drain cleaning device, wherein the section is generally cut along the cutting-plane line F-F in FIG. 76;

FIG. 78 is a perspective view illustrating the manner in which the drain cleaning device of FIG. 70A may be used to clean a drain pipe of a sink drain;

FIG. 79 is an enlarged broken perspective view of a drain cleaning device, according to yet another illustrative embodiment of the invention, wherein the elongated shaft is provided with an extended hook material strip at the end thereof; and

FIG. 80 is a longitudinal sectional view cut through the distal end portion of the elongated shaft so as to illustrate the extended hook material strip at the end thereof, wherein the section is generally cut along the cutting-plane line G-G in FIG. 79.

Throughout the figures, the same parts are always denoted using the same reference characters so that, as a general rule, they will only be described once.

### DETAILED DESCRIPTION OF EMBODIMENTS OF THE INVENTION

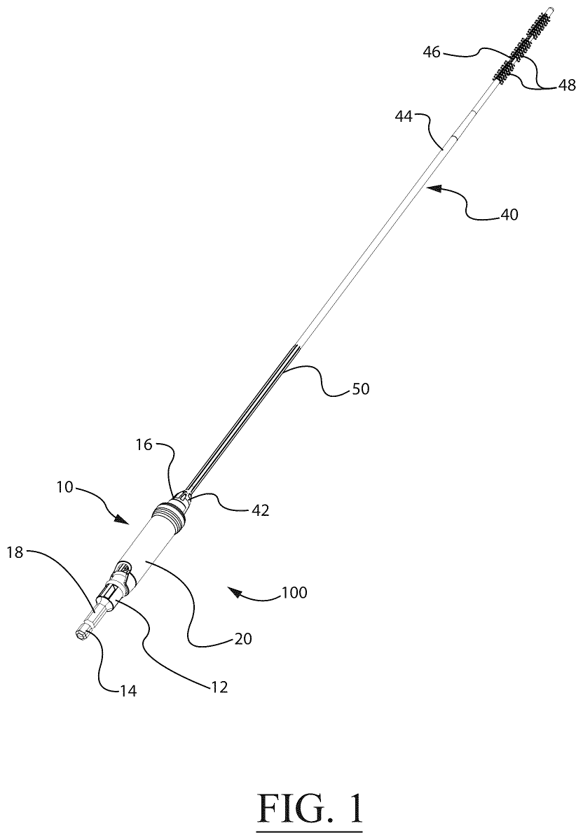

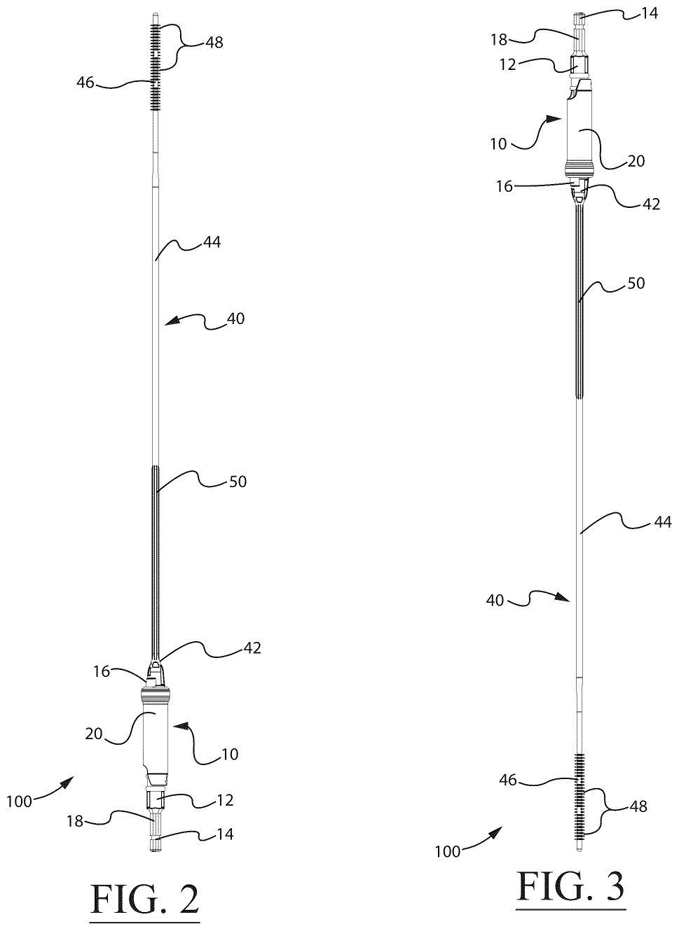

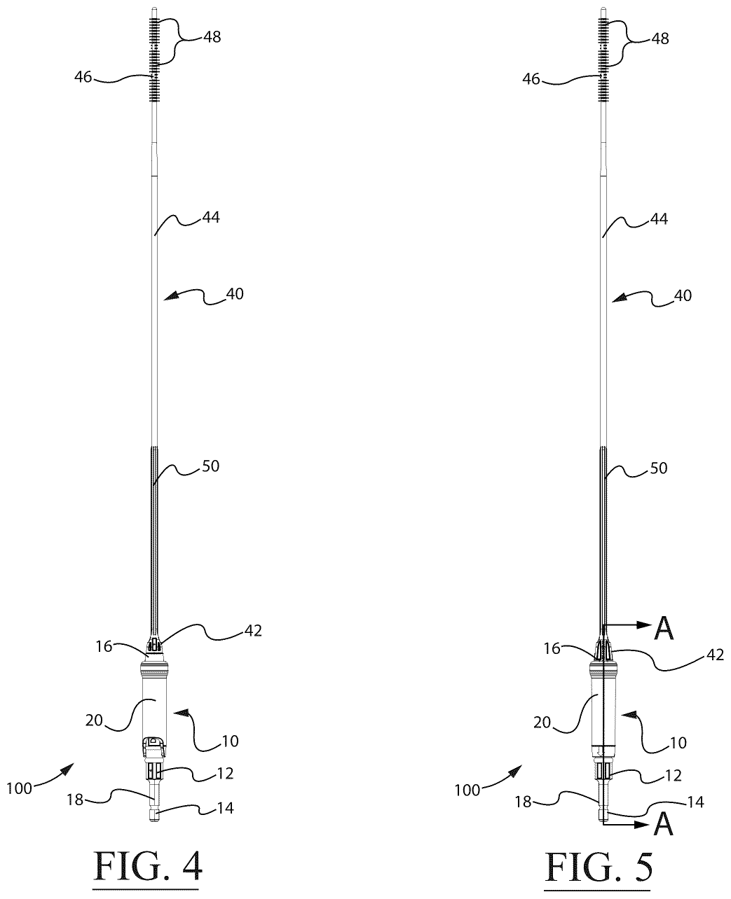

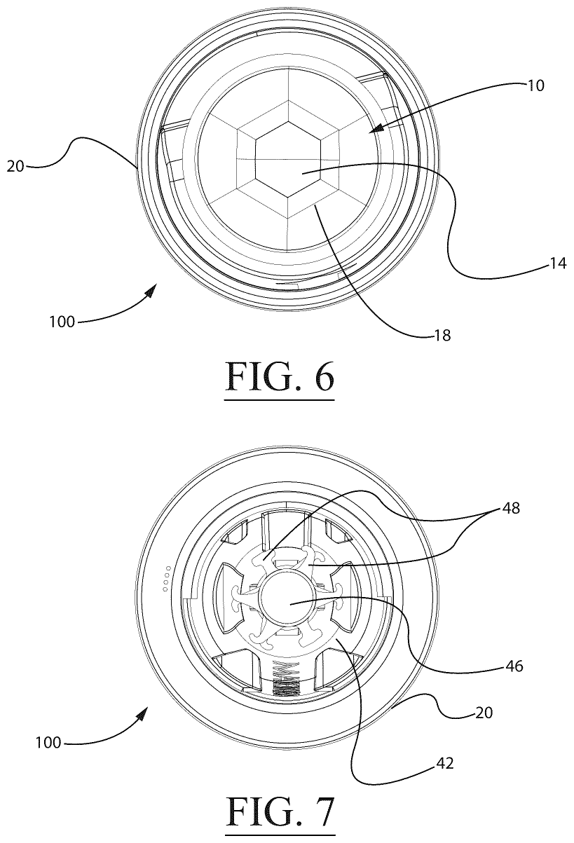

A first illustrative embodiment of a drain cleaning assembly is seen generally at 100 in FIGS. 1-7. FIG. 1 shows a perspective view of the illustrative drain cleaning assembly 100 including a reusable power tool adapter 10 and a disposable drain cleaning device 40. The disposable drain cleaning device 40 is attached to the power tool adapter 10 by engagement of the proximal end portion 42 (i.e., the end that is closest to the person when operating the device) of the drain cleaning device 40 fully engaged with the distal end portion 16 of the power tool adapter 10. A slidable sleeve member 20 is shown in the engaged position and the drain cleaning device 40, as shown in FIG. 1, is in the fully engaged configuration. The sleeve member 20 in this engaged position ensures that the drain cleaning device 40 and power tool adapter 10 are fully engaged, i.e., interlocked at their corresponding ends, and the device is ready for use, such as for clearing a clogged drain pipe or for other similar pipe-cleaning functions.

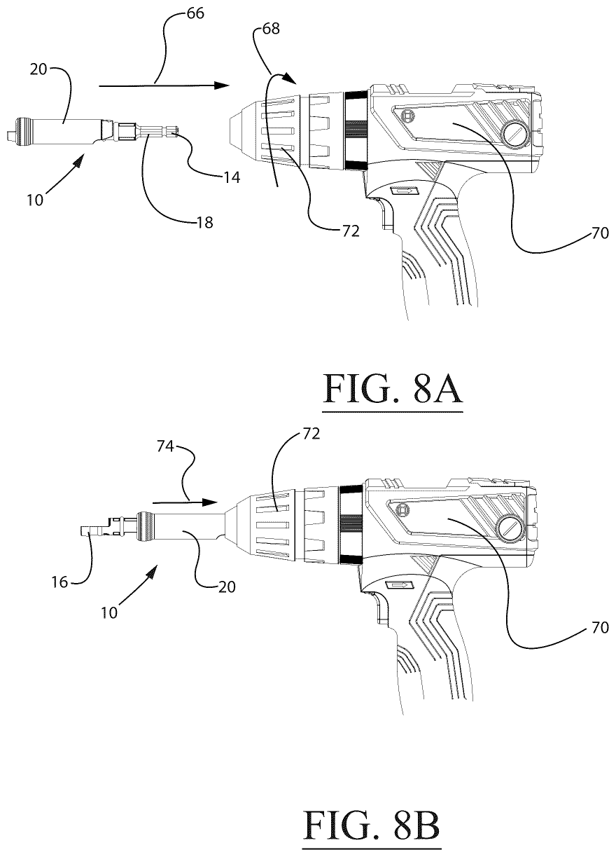

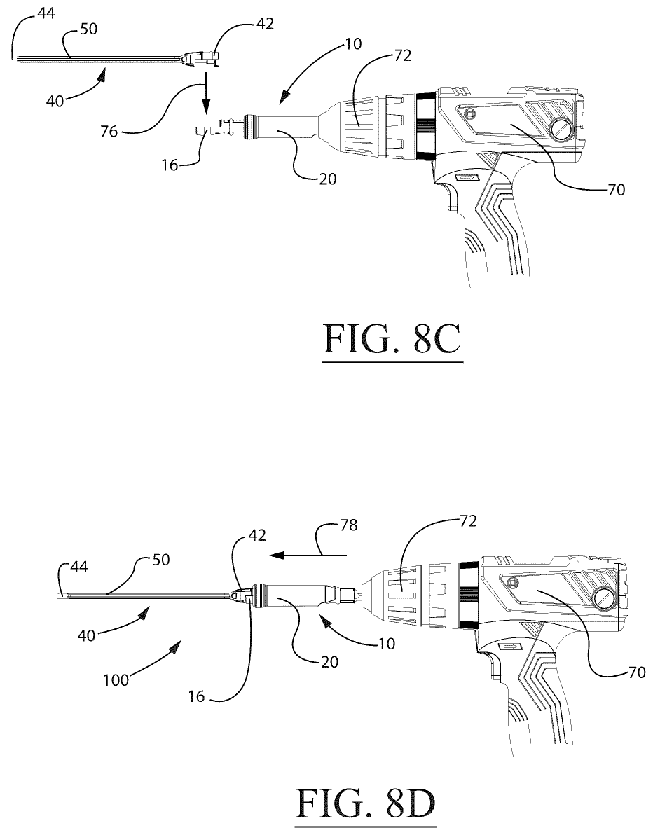

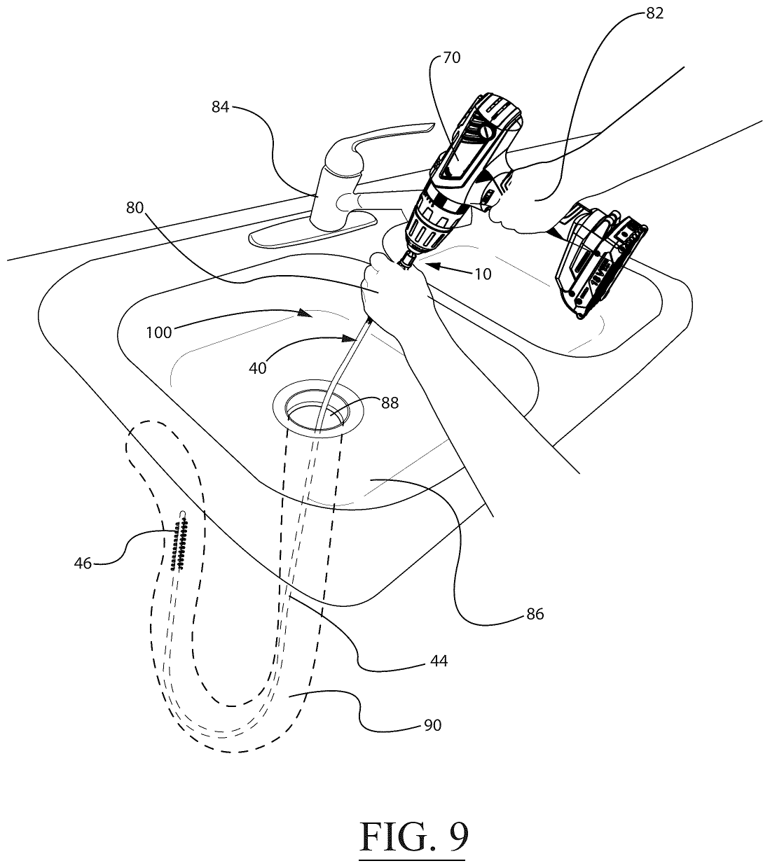

In the illustrative embodiment, as shown in FIGS. 1-5 and 11, the power tool adapter 10 generally comprises an adapter body 12 having a proximal end portion 14 and a distal end portion 16, the proximal end portion 14 of the adapter body 12 being oppositely disposed relative to the distal end portion 16 of the adapter body 12. In FIGS. 1-5, it can be seen that the distal end portion 16 of the adapter body 12 is configured to be coupled to a drain cleaning device 40 having a plurality of hook elements 48 disposed thereon, the plurality of hook elements 48 configured to grab and collect debris from a drain pipe. Also, as shown in FIGS. 1-5, the proximal end portion 14 of the adapter body 12 is configured to be coupled to a rotary motion input device (e.g., a drill 70—see FIGS. 8A-8D) that is sufficient to rotate the plurality of hook elements 48 of the drain cleaning device 40 about a rotational axis so as to grab and collect the debris from a drain pipe 88 (refer to FIG. 9).

In the illustrative embodiment, as shown in FIGS. 1-5 and 8A, it can be seen that the proximal end portion 14 of the adapter body 12 of the power tool adapter 10 comprises a shank section 18 for being inserted into a recess of the rotary motion input device (e.g., a drill 70). For example, the rotary motion input device for rotating the drain cleaning device 40 may comprise a drill, a screwdriver, a power drill, or a power screwdriver. In the illustrative embodiment, the power tool adapter 10 is configured for use with a drill 70, and the shank section at the proximal end portion of the adapter body is in a form of a drill bit shank section 18 for being inserted into a drill chuck recess. In the illustrative embodiment of FIGS. 1-5 and 8A, the drill bit shank section 18 has a generally hexagonal cross-sectional shape for being inserted into the drill chuck recess. In another embodiment, the drill bit shank section may have a generally circular cross-sectional shape for being inserted into the drill chuck recess.

In the illustrative embodiment, as will be described in further detail hereinafter, a user inserts the drill bit shank section 18 into a drill and tightens the chuck in the same fashion as using a drill bit. The slidable sleeve member 20 moves axially along the center of the power tool adapter 10 between an engaged position (i.e., a locking position) and a disengaged position (i.e., a release position). This sliding action of the sleeve member 20 fully engages or releases the replaceable drain cleaning device 40, which attaches to the distal end portion 16 of the adapter body 12. Once the drill bit shank section 18 of the power tool adapter 10 is locked into the drill chuck, the user grasps the drill in one hand and the spinning sleeve member 20 with the other hand, and inserts the attached drain cleaning device 40 into a sink or tub drain until they engage the resistance of a clog. Then, rather than having to manually crank the device 40, the user simply runs the drill on slow speed and allows the drill to power the drain cleaning device 40, rather than using the effort of manually cranking the device 40. The user can then detach the removable drain cleaning device 40 by sliding the spinning sleeve 20 of the power tool adapter 10 up toward the proximal drill end, exposing the mated, interlocking ends of both the adapter 10 and removable drain cleaning device 40, thereby allowing for removal and replacement of the drain cleaning device 40.

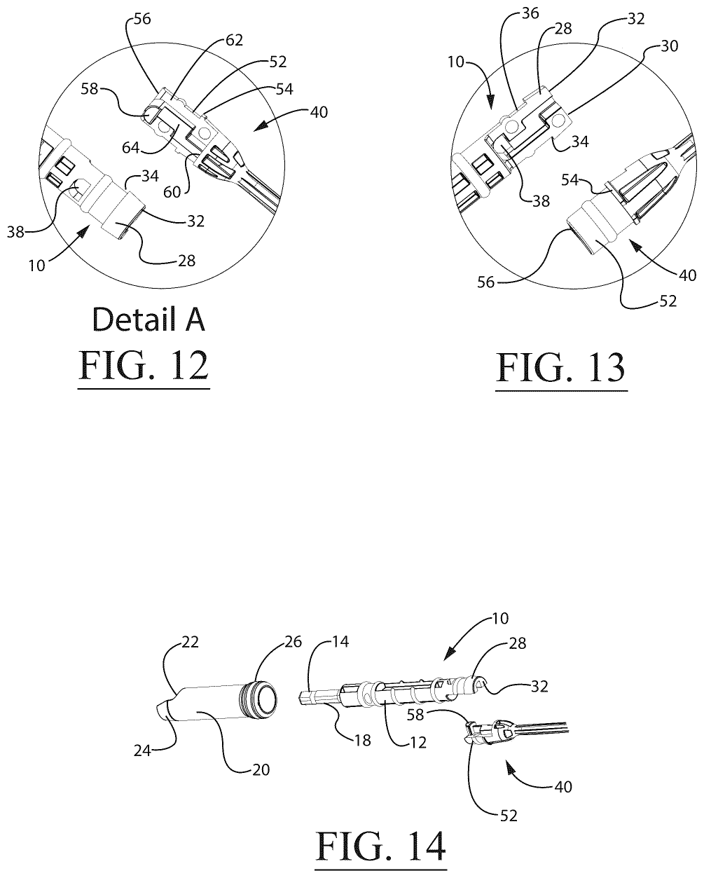

In the illustrative embodiment, the sleeve member 20 of the power tool adapter 10 can be moved back and forth between two possible positions along the adapter body 12: (i) a disengaged position (see FIGS. 12 and 13) where the drain cleaning device 40 is able to be released from the power tool adapter 10, and (ii) an engaged position (see FIGS. 1-5) where the distal end portion 16 of the adapter body 12 is locked into engagement with the proximal end portion 42 of the drain cleaning device 40.

As shown in FIGS. 1-5 and 7, the distal tip section 46 of the drain cleaning device 40 can be equipped with a hair-catching structure (e.g., a plurality of hook elements 48) that collects hair material or debris clogging a drain.

After use, the drain cleaning device 40 is disengaged from the power tool adapter 10 (as described below) and can be discarded in an appropriate disposal receptacle, or in an appropriate recycling collection container.

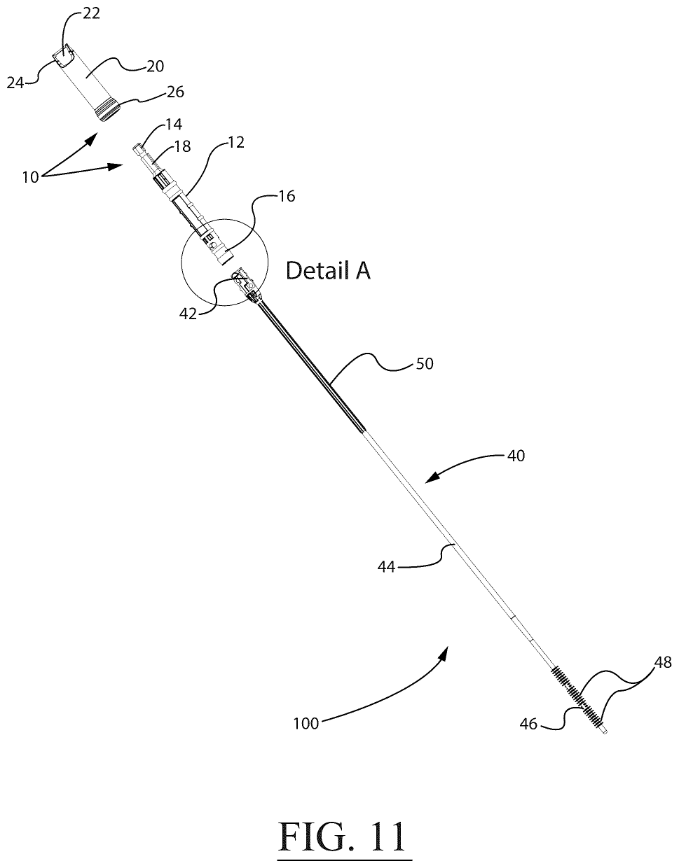

In the illustrative embodiment, the sleeve member 20 of the power tool adapter 10 has a generally cylindrical shape, but may include a notch 22 at its proximal end 24 (sec FIGS. 11 and 14). When the sleeve member 20 is moved backward to its disengaged position (i.e., the FIG. 8B position), the interlocking ends of the drain cleaning device 40 and power tool adapter 10 are exposed and can be detached.

In the illustrative embodiment, the interlocking region at the proximal end of the drain cleaning device 40 includes a partial annular shoulder stop 54 and a partial cylindrical end section 52 that match a respective partial annular shoulder stop 34 and partial cylindrical end section 28 at the distal end of the power tool adapter 10 (see FIGS. 12 and 13). When the sleeve member 20 is moved to the disengaged position as shown in FIG. 8B, the two corresponding partial cylindrical portions 28 and 52, are exposed and can be decoupled or detached. Alternatively, when the sleeve member 20 is moved to the engaged position (see FIGS. 1-5 and 8D), the distal end 26 of the sleeve member 20 is moved axially forward until it rests against the two partial annular shoulder stops, 34 and 54. When a drain cleaning device 40 is engaged, i.e., its proximal end portion 42 is interlocked with the distal end portion 16 of the power tool adapter body 12, the sleeve member 20 can be moved to its engaged position and the drain cleaning device 40 is ready for use and can be properly operated.

The interlocking region of the drain cleaning device 40 and the power tool adapter 10 is shown in more detail in the illustrative embodiment of FIGS. 12 and 13.

When the sleeve member 20 is moved to its disengaged position, the drain cleaning device 40 can be disengaged from the distal end portion 16 of the power tool adapter 10. In this position, the partial cylindrical end section 28 at the distal end of the power tool adapter 10 is clearly exposed (see FIG. 8B).

When interlocked with the corresponding end of the drain cleaning device 40, the partial cylindrical end section 52 of the drain cleaning device 40 combines with the partial cylindrical end section 28 at the distal end of the power tool adapter 10 to form a generally cylindrical interlocked structure that fits inside the bore of the sleeve member 20; and this interlocked structure can rotate inside the sleeve member 20 (e.g., during routine operation) when the sleeve is moved to the engaged position.

In addition, in the illustrative embodiment shown in FIGS. 1-5, when the drain cleaning device 40 is interlocked with the power tool adapter 10, protrusion 58 (see FIG. 12) of the drain cleaning device 40 fits in the corresponding opening 38 (see FIGS. 12 and 13), and axial stop 60 and surfaces 62 and 64 of the proximal end of the drain cleaning device 40 fit in the corresponding stop 32 and surfaces 30 and 36 at the distal end of power tool adapter 10 (refer to FIGS. 12-14).

In the illustrative embodiment, a further shaped axial stop surface 56 is provided at the proximal end of the drain cleaning device 40 (see FIGS. 12 and 13), which matches a correspondingly shaped cavity or opening (in axially proximal surface of opening 38) in the distal end of the power tool adapter 10 to ensure a uniquely matched interlock between the drain cleaning device 40 and the power tool adapter 10. That is, as best shown in FIGS. 12 and 13, the partial cylindrical end section 52 of the drain cleaning device 40 is provided with an internal zigzag protruding surface 64 that interlocks with an internal zigzag recess in the partial cylindrical end section 28 of the power tool adapter 10 connected to opening 38.

In the illustrative embodiment, a further detent can be provided at the distally lower surface of protrusion 58 to engage with a corresponding receiving indentation in the radially outer portion of opening 38 in the power tool adapter 10, in order to ensure a snap fit or other secure attachment.

In the illustrative embodiment, contact surface 62 at the distal end of the drain cleaning device 40 mates with corresponding contact surface 36 at the distal end of power tool adapter 10, when the drain cleaning device 40 and power tool adapter 10 are fully engaged. Similarly, when engaged, axial stop surface 60 at the end of the drain cleaning device 40 mates with the corresponding adapter stop surface 32. Furthermore, any tab feature, as shown projecting from surface 36 of the distal end of the power tool adapter 10, can be provided to mate with a corresponding opening in the proximal end of the drain cleaning device 40.

However, it is noted that the combination of the protrusion 58 and corresponding opening 38, as well as other notch-opening relationships between the proximal end of the drain cleaning device 40 and the distal end of the power tool adapter 10 are exemplary of mating relationships that can vary in size and shape. It is most important that the mating contours of the proximal end of the drain cleaning device 40 and the corresponding distal end of the power tool adapter 10 match in a manner that ensures the adequate transmission of the torque produced by the power tool (e.g., the drill 70 in FIG. 9) to the distal tip section 46 of the drain cleaning device 40 without loosening or disengaging the two interlocked ends during use. It is also important that different reusable power tool adapters 10 be provided with unique mating contours at the interlocking end section to match drain cleaning devices 40 that are uniquely matched to mate and interlock with the reusable power tool adapter 10.

The particular contour of the matching shaped protrusion of the drain cleaning device 40 and shaped opening of the power tool adapter 10, ensure that a unique drain cleaning device 40 can be uniquely engaged with a correspondingly unique power tool adapter 10.

A kit containing a set of differently shaped drain cleaning devices, each with a correspondingly matched power tool adapter 10, can be used, so long as the interlocking ends are suitably matched and the rotation of the power tool adapter 10 can cause the rotation of the drain cleaning device to remove debris from piping structures. Different kits can contain drain cleaning devices that are matched to one unique power tool adapter 10, or to more than one power tool adapter in different kits. The drain cleaning devices in any individual kit have interlocking portions with proximal contours that match the corresponding contours of the interlocking portions of the power tool adapters in the individual kits.

In the illustrative embodiment, with reference to FIGS. 1-5, it can be seen that the drain cleaning device 40 generally comprises an elongated rod section 44 with a plurality of longitudinally extending ribs 50 disposed along a length thereof, the plurality of longitudinally extending ribs 50 configured to add structural rigidity to the elongated rod section 44, and the plurality of longitudinally extending ribs 50 further configured to facilitate the cleaning of grime from a side of a drain pipe 90 (see FIG. 9); and a tip section 46 connected to the elongated rod section 44, the tip section 46 including a plurality of hook elements 48 disposed thereon (see FIGS. 1-5), the plurality of hook elements 48 configured to grab and collect debris from the drain pipe 90.

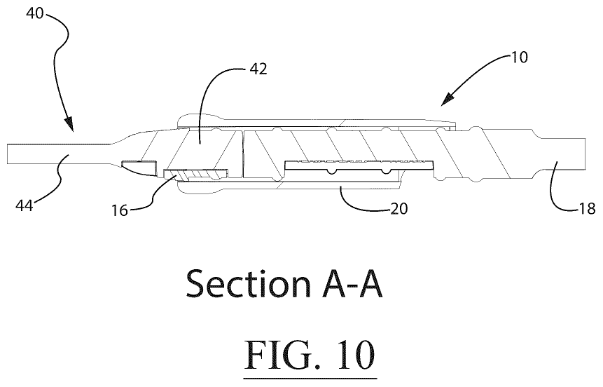

In the illustrative embodiment, the plurality of hook elements 48 of the tip section 46 are in the form of a plurality of injection-molded micro-hook elements configured to grab and collect the hair and/or debris from the drain pipe being cleaned. In the illustrative embodiment, the plurality of injection-molded micro-hook elements may be in the form of inverted J-shaped projections and T-shaped projections protruding outwardly from the elongated body of the cleaning device 40. The plurality of injection-molded micro-hook elements may be disposed on opposite first and second sides of the elongated body of the cleaning device 40. The injection-molded micro-hook inverted J-shaped elements that are disposed on the first side and the second side of the elongated body of the cleaning device may be arranged in rows where every other injection-molded micro-hook element points in an opposite direction (i.e., the injection-molded micro-hook elements point in alternating directions along the length of the elongated body—see e.g., FIGS. 10-12 in U.S. Pat. No. 10,857,577, the entire disclosure of which is incorporated herein by reference).

In other embodiments, the plurality of hook elements of the drain cleaning device 40 may comprise a hook material strip 30 (e.g., made from the hook portion of Velcro®—see e.g., FIGS. 5 and 9 of U.S. Pat. No. 10,857,577), rather than being injection-molded micro-hook elements.

In the illustrative embodiment, the drain cleaning devices 40 are preferably disposable and can be made of any suitable disposable, recyclable or biodegradable material (e.g., a suitable plastic), such as polyethylene, polystyrene, polycarbonate, acrylic polymer, or nylon. The power tool adapter 10 is preferably reusable and can be made of a suitably durable material (e.g., a suitable plastic) to withstand repeated engagement and disengagement with drain cleaning devices 40 and repeated use.

Now, with reference to the illustrative embodiment of FIGS. 8A-8D, the manner in which the drain cleaning assembly 100 is attached to a driving power tool (e.g., a drill 70) will be explained. First of all, as shown in FIG. 8A, the drill bit shank section 18 of the power tool adapter 10 is inserted into the chuck 72 of the battery-powered drill 70 by a user (as diagrammatically indicated by the horizontal arrow 66), and then the user tightens the jaws of the drill chuck 72 onto the drill bit shank section 18 of the power tool adapter 10 using the tightening collar of the chuck 72 (as diagrammatically indicated by the curved arrow 68). Secondly, as shown in FIG. 8B, the user slides the sleeve member 20 into its disengaged position (as diagrammatically indicated by the horizontal arrow 74). Then, turning to FIG. 8C, the user engages the proximal end portion 42 of the drain cleaning device 40 with the distal end portion 16 of the power tool adapter 10 (as diagrammatically indicated by the vertical arrow 76). Finally, once the proximal end portion 42 of the drain cleaning device 40 is engaged with the distal end portion 16 of the power tool adapter 10, the user slides the sleeve member 20 into its engaged position (as diagrammatically indicated by the horizontal arrow 78 in FIG. 8D) so as to secure the drain cleaning device 40 to the power tool adapter 10.

When the drain cleaning assembly 100 is in the fully engaged configuration as shown in FIG. 8D, the drain cleaning assembly 100 is ready for use. The distal tip section 46 of the drain cleaning device 40 can be inserted into a clogged drain or other similarly obstructed pipe. The user then places one hand 80 on the sleeve member 20 of the power tool adapter 10 and uses the other hand 82 to hold the drill 70. Pressing the trigger on the drill 70 causes the drain cleaning device 40 to rotate inside the clogged drain or obstructed pipe, thereby removing obstructing materials. The power tool adapter 10 can be turned indefinitely to rotate the drain cleaning device 40, thereby continuously collecting debris at the distal end of the drain cleaning device 40.

In FIG. 9, the operation of the drain cleaning assembly 100 is illustrated. More specifically, FIG. 9 shows the inventive drain cleaning assembly 100 being used in a sink 86 to remove clogging debris from the drain pipe 90 of the sink 86. The sink 86 has an associated faucet 84 for dispensing water into the sink 86. In the illustrative embodiment, the diameter of the elongated rod section 44 of the device 40 is sufficiently narrow to be easily inserted through openings in a typical drain cover all the way to the drain trap, often found in older residential bathrooms or modern drains having pop-up stoppers. Referring again to FIG. 9, after insertion of the elongated rod section 44 into the drain 88, the drain cleaning device 40 is rotated by the drill 70, thus winding into and capturing the clogging debris. The particular construction of the hook elements on the tip section 46 allows the debris to be collected and grabbed by the drain cleaning device 40. After grabbing the clogging debris, the device 40 is removed from the drain 88.

In one or more embodiments, the drain cleaning device 40 is configured to be discarded after being used to remove the debris from the drain pipe 90. In other words, the drain cleaning device 40 is disposable, and is designed for single cleaning of a drain. The used drain cleaning device 40 with the collected debris can be safely and environmentally discarded. Then, a new drain cleaning device 40 can be attached to the power tool adapter 10, and used to remove hair from another clogged drain.

A second illustrative embodiment of a drain cleaning assembly is seen generally at 200 in FIGS. 15-17. FIG. 15 shows a perspective view of the illustrative drain cleaning assembly 200 including the reusable power tool adapter 10 and a disposable drain cleaning device 240. Referring to these figures, it can be seen that, in many respects, the illustrative embodiment of FIGS. 15-17 is similar to that of the illustrative embodiment of FIGS. 1-7. Moreover, many elements are common to both such embodiments. For the sake of brevity, the elements that the illustrative embodiment of FIGS. 15-17 has in common with the embodiment of FIGS. 1-7 will not be discussed in detail because these components have already been described above.

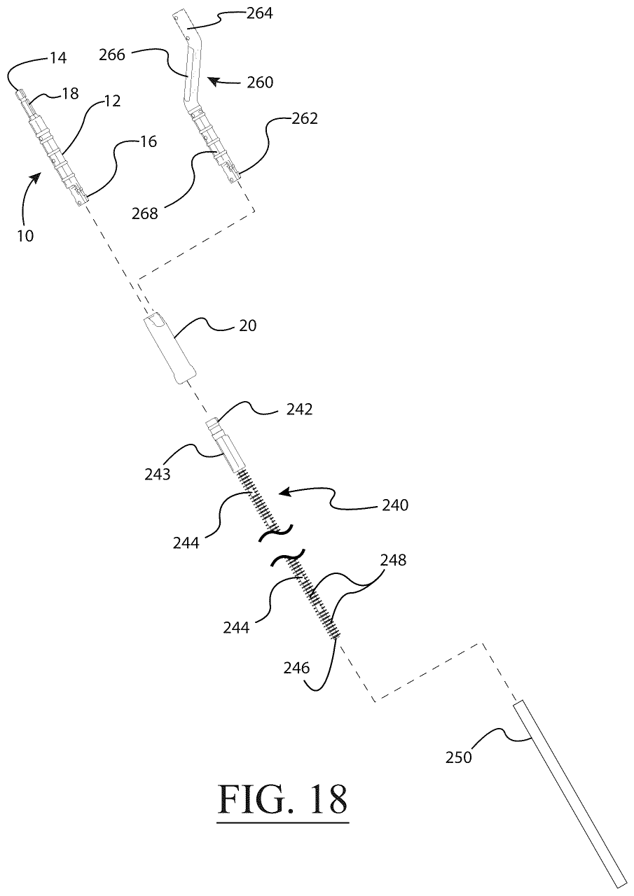

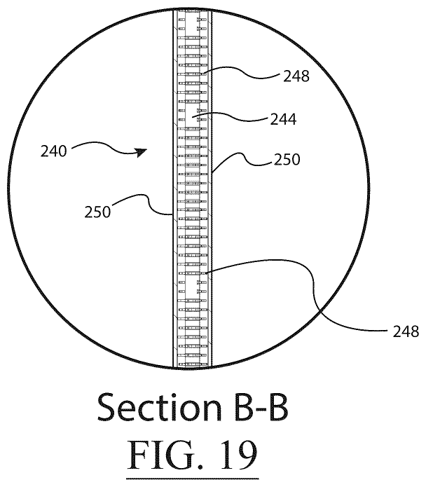

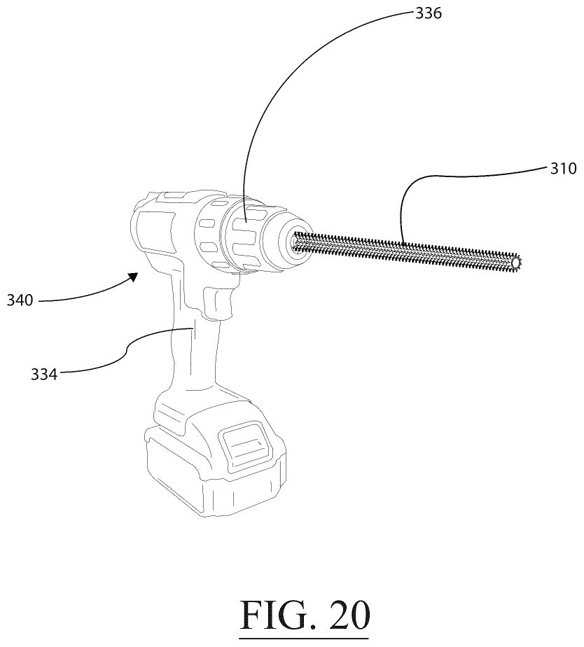

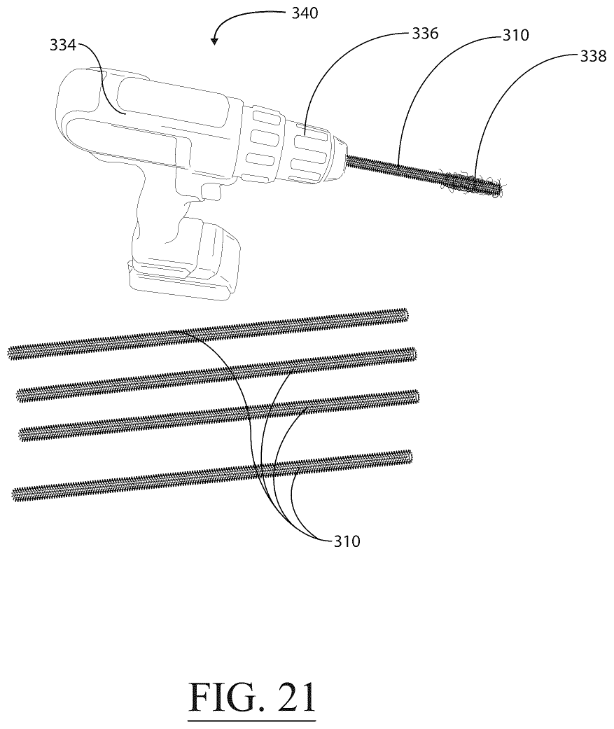

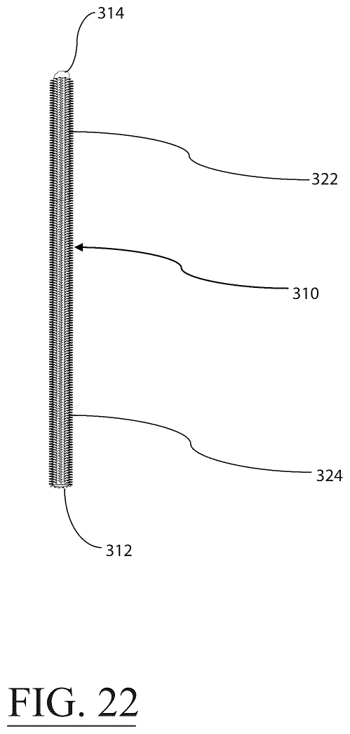

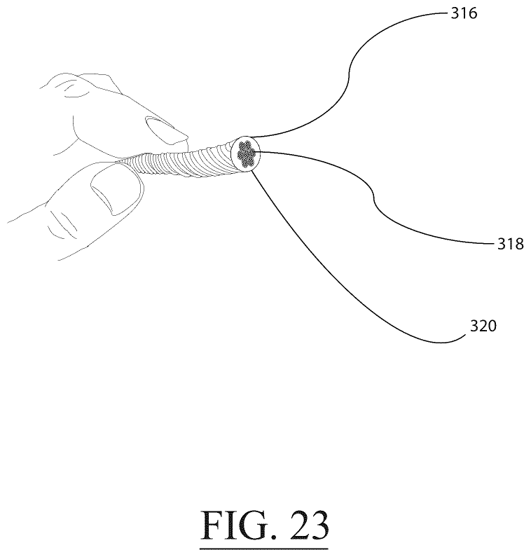

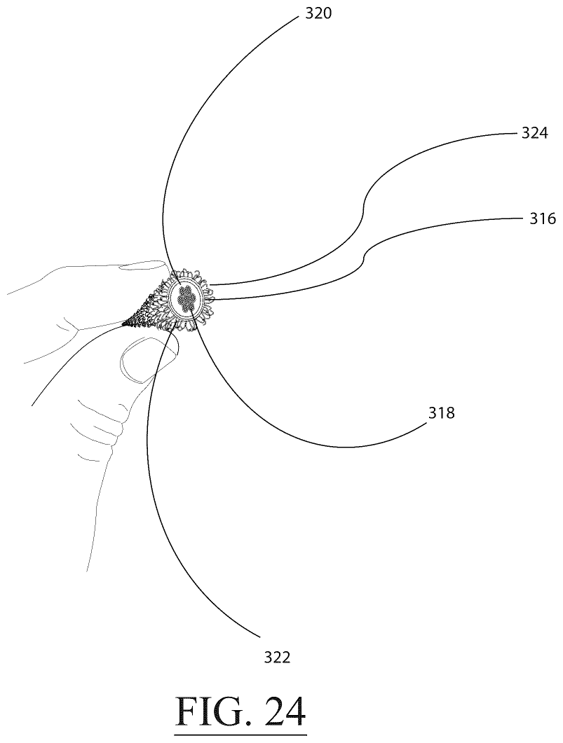

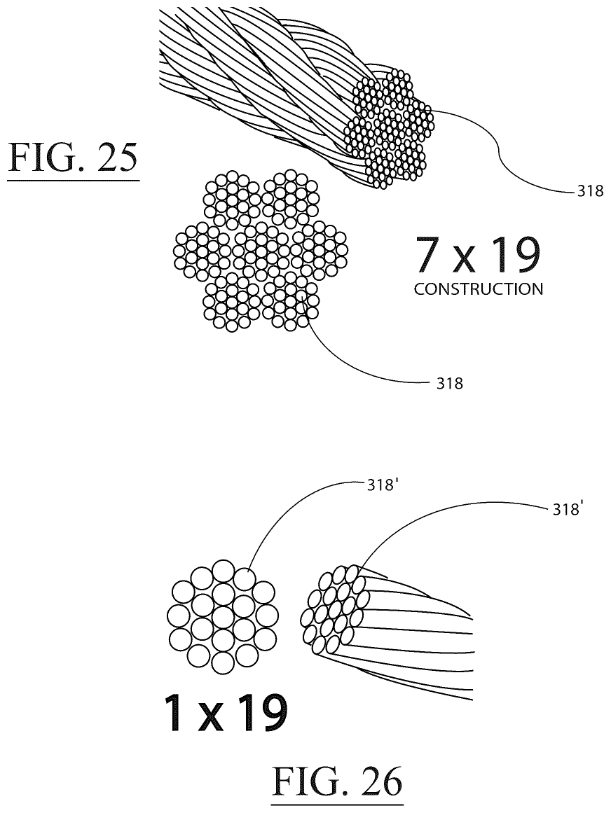

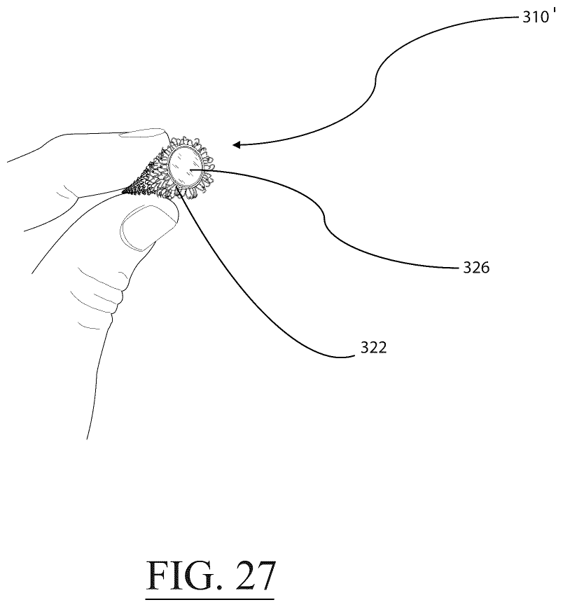

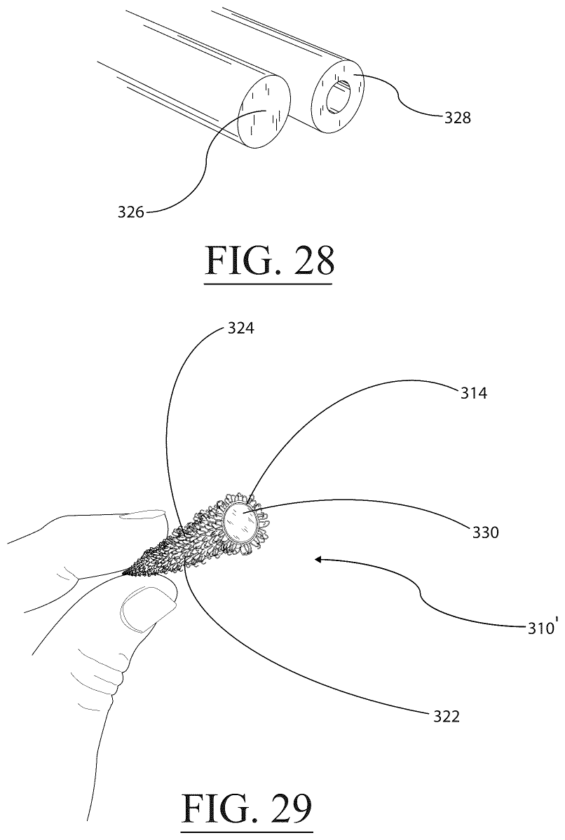

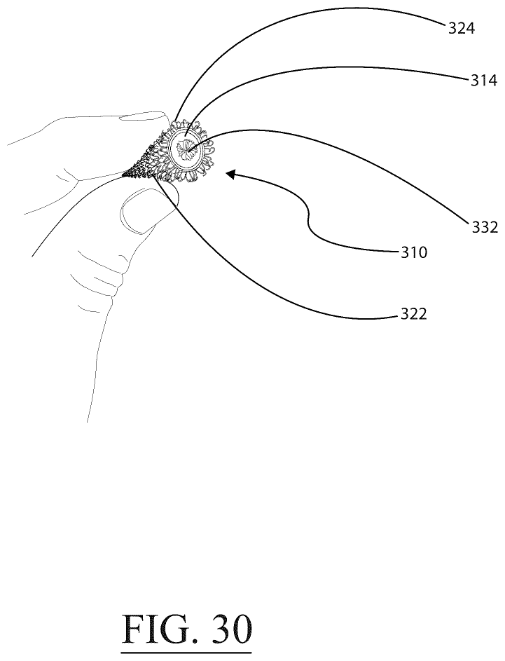

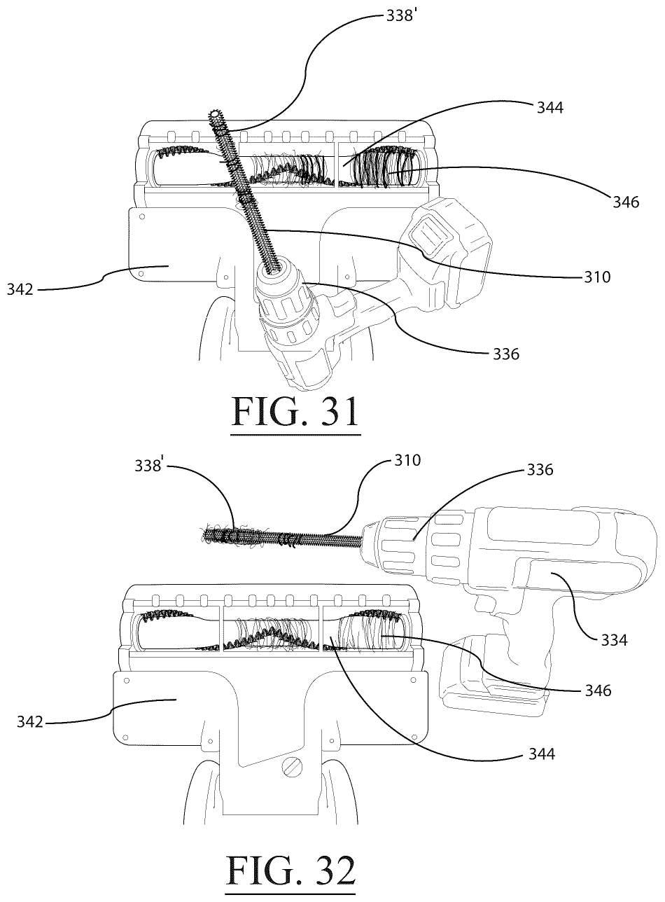

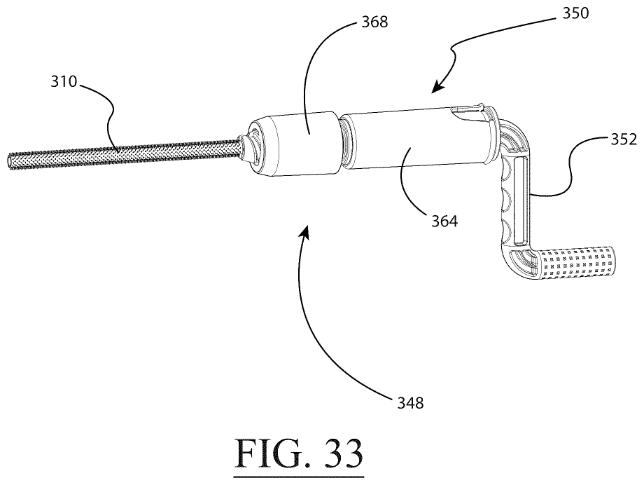

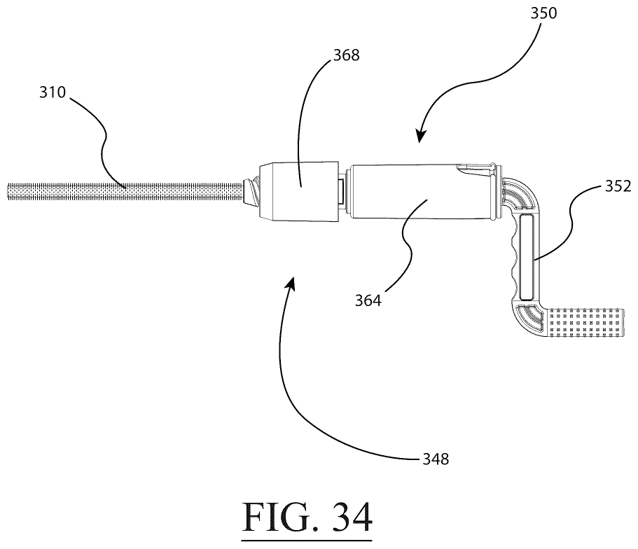

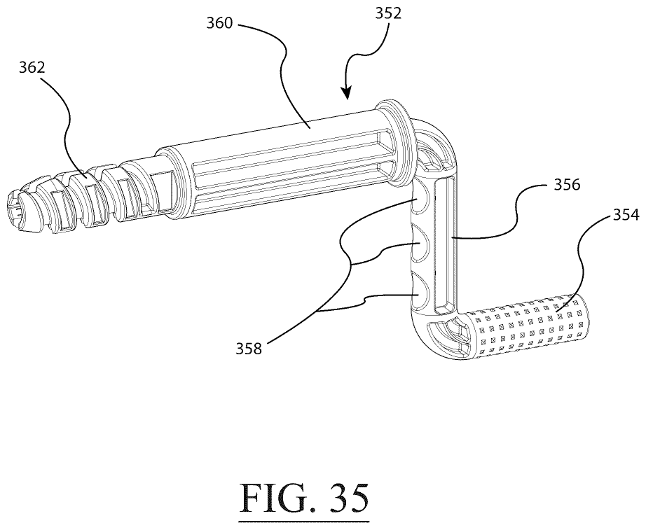

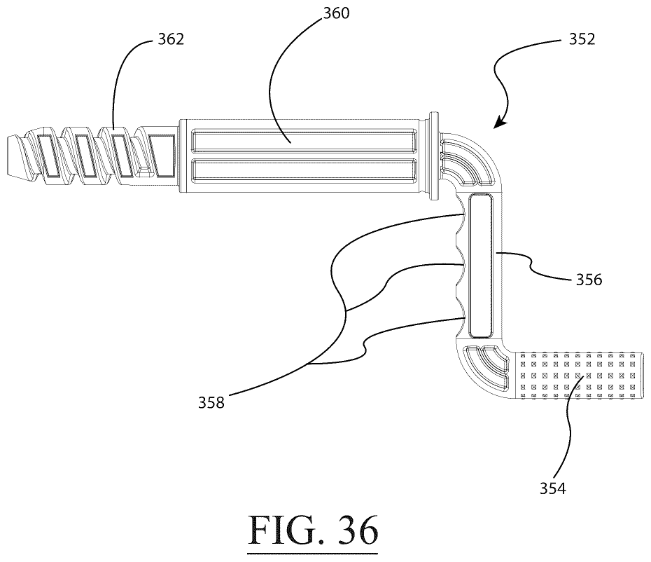

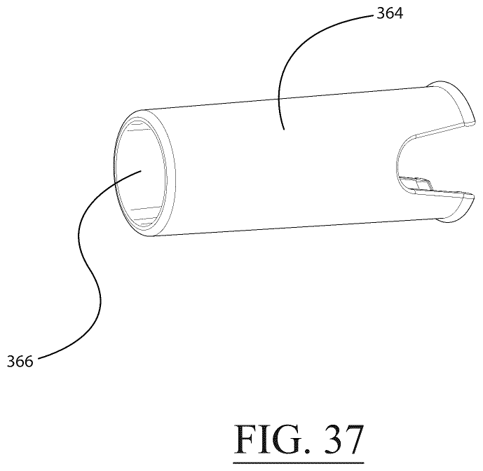

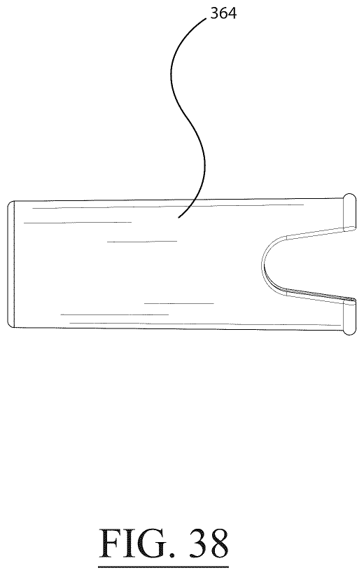

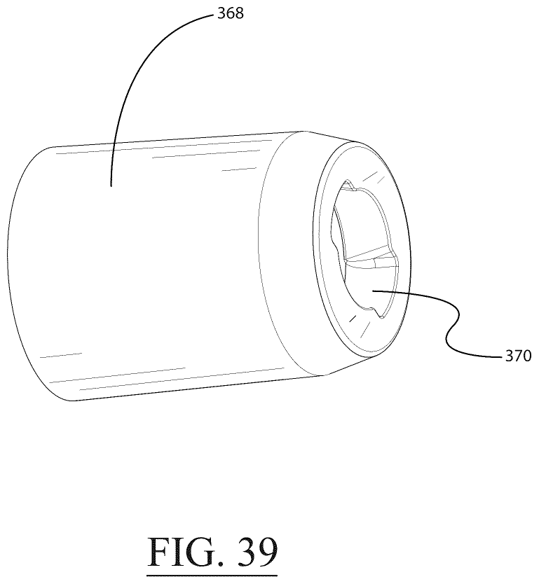

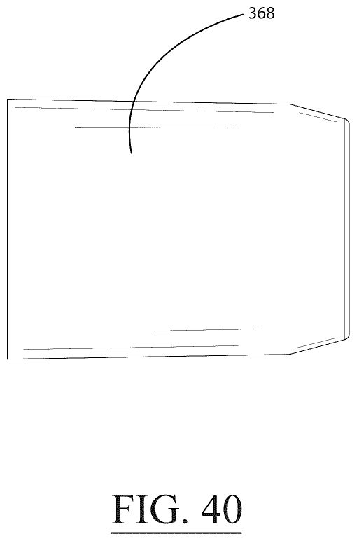

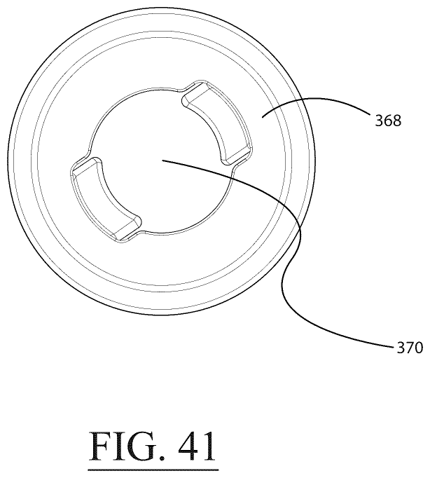

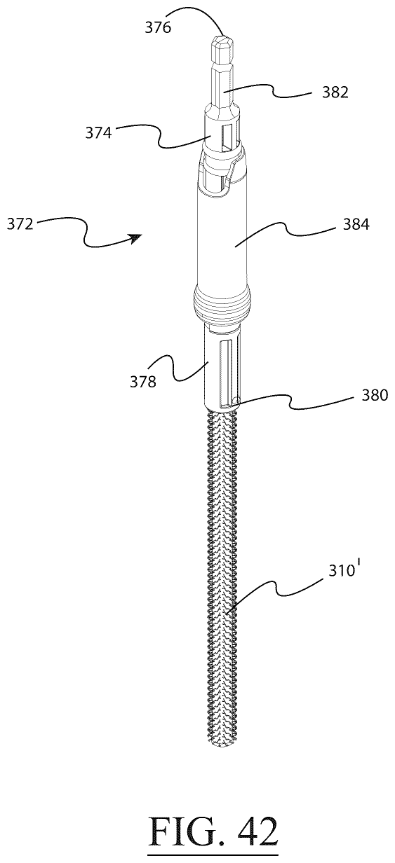

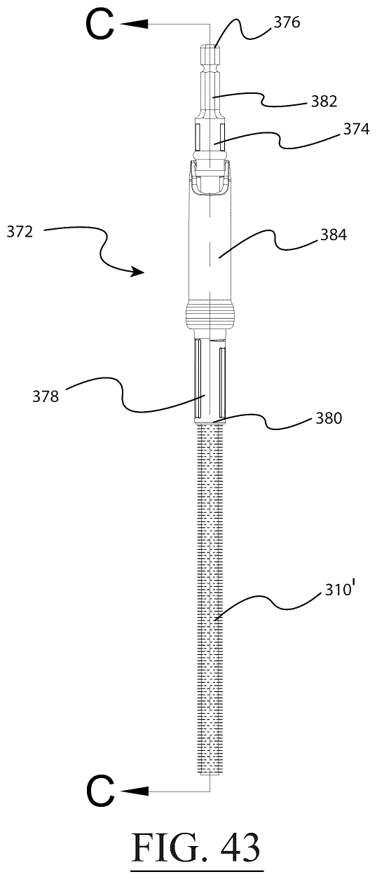

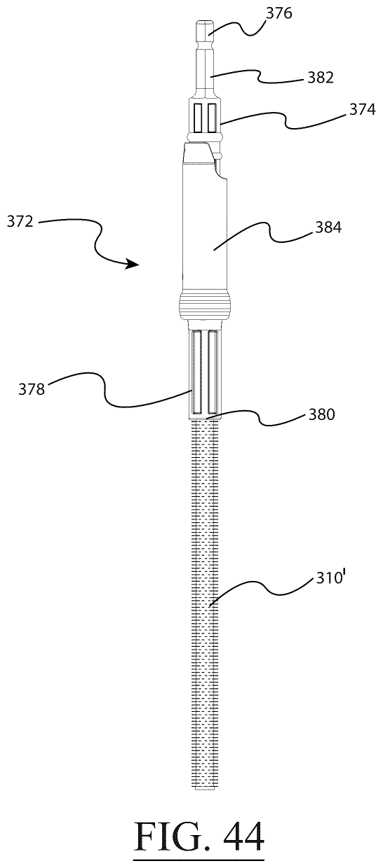

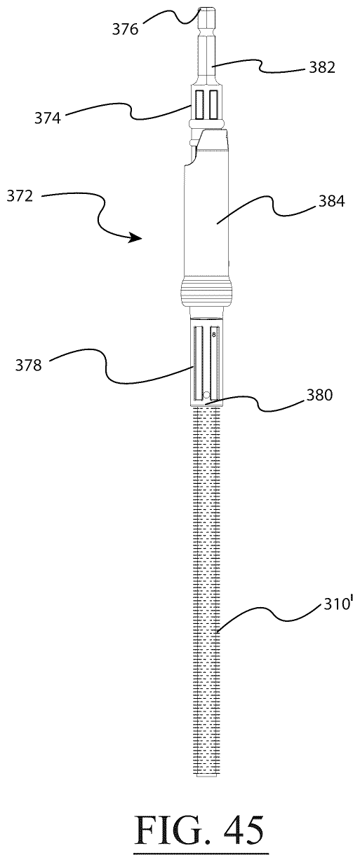

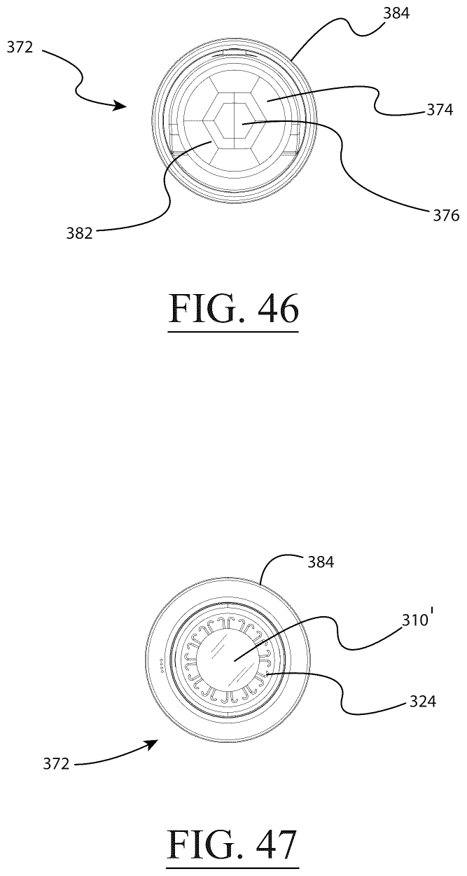

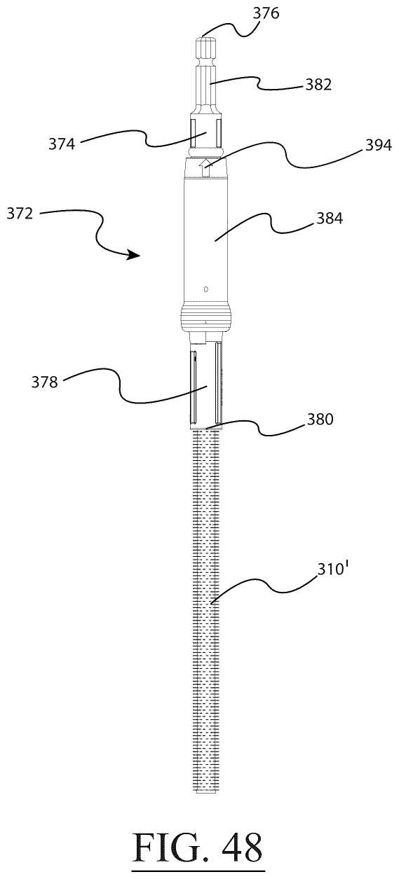

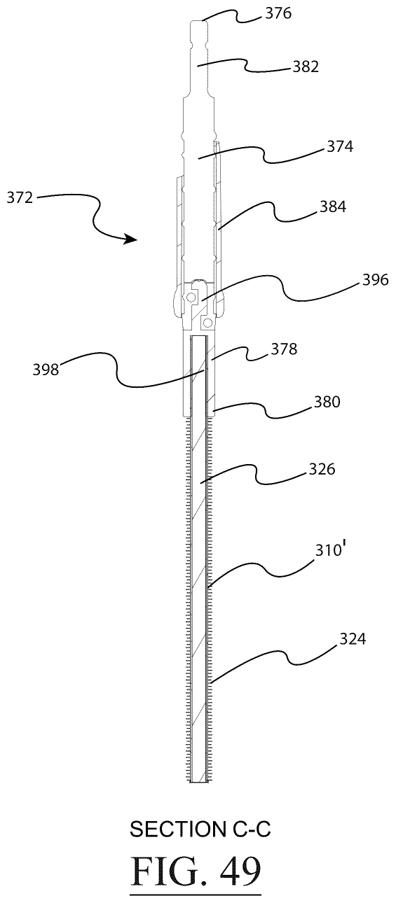

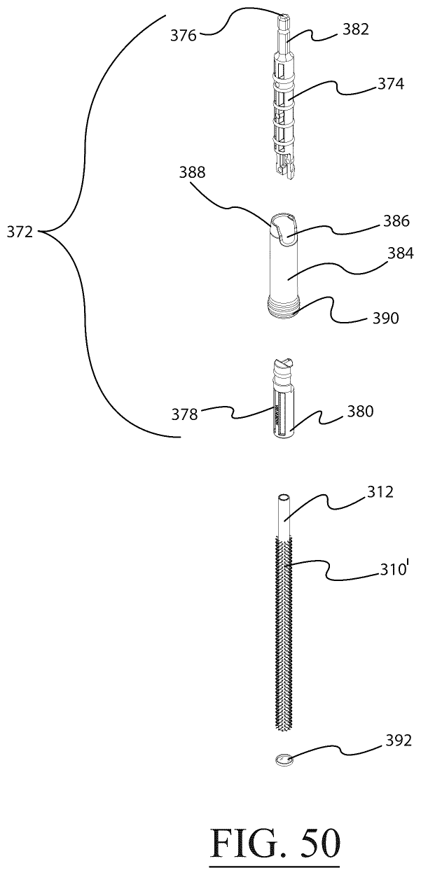

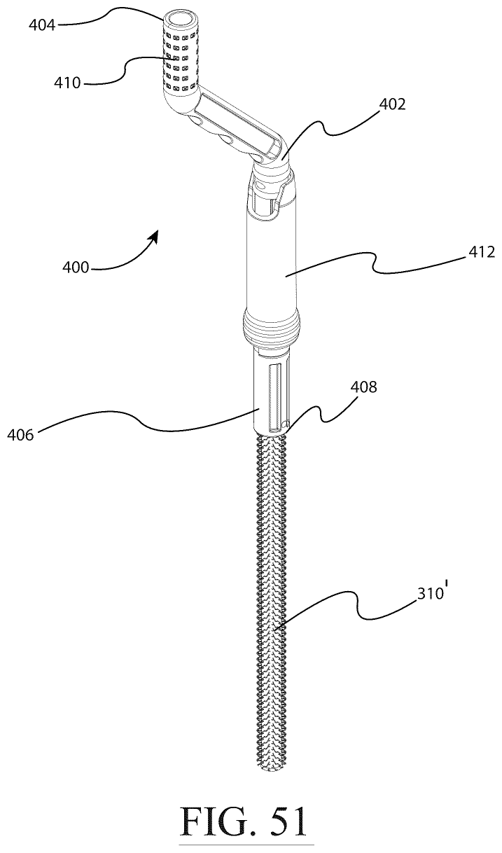

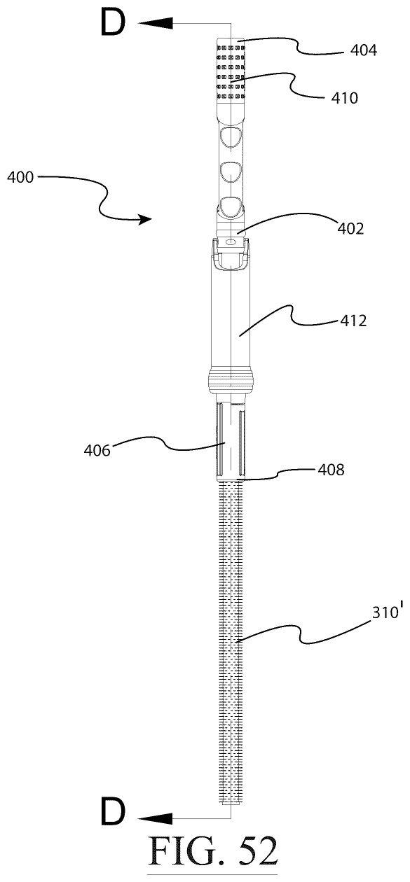

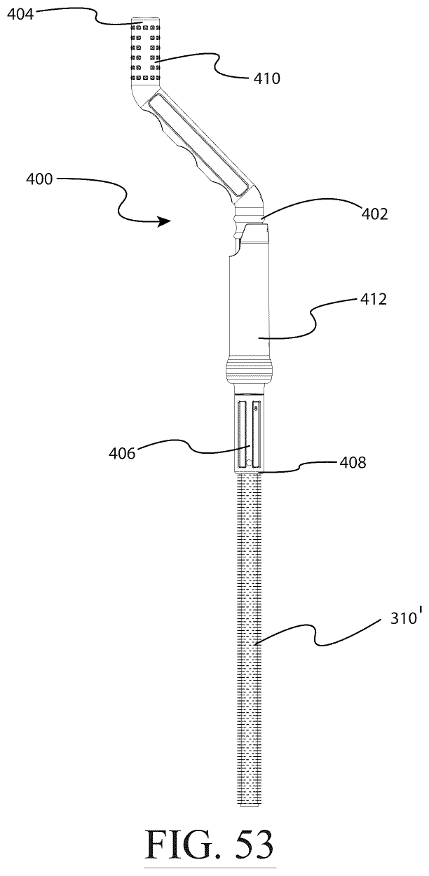

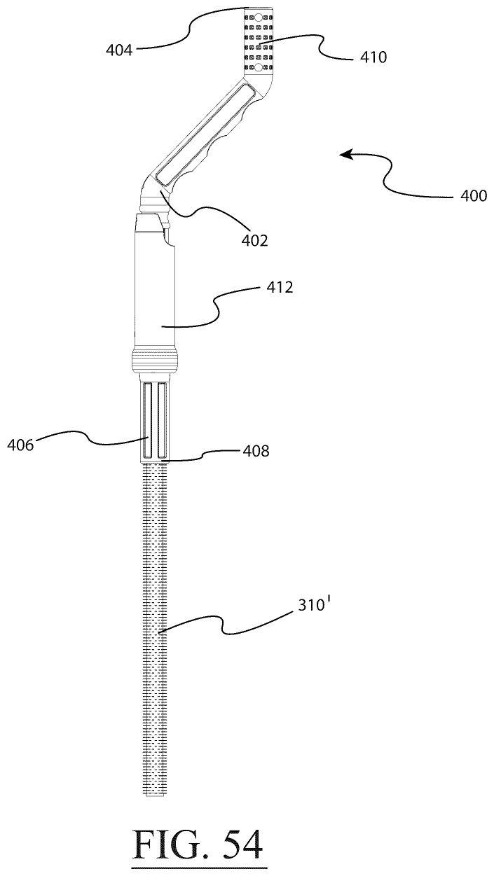

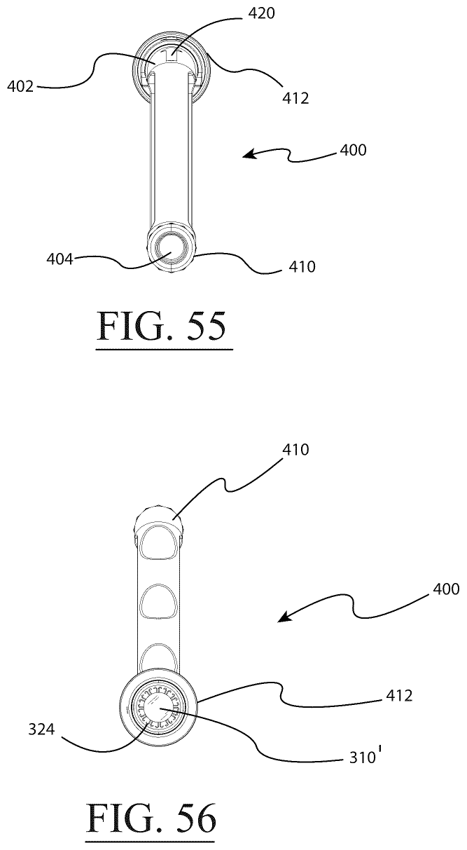

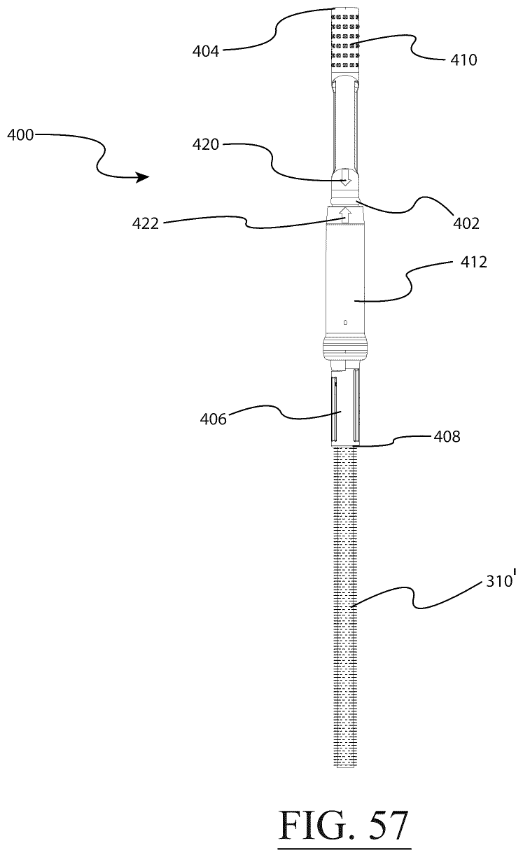

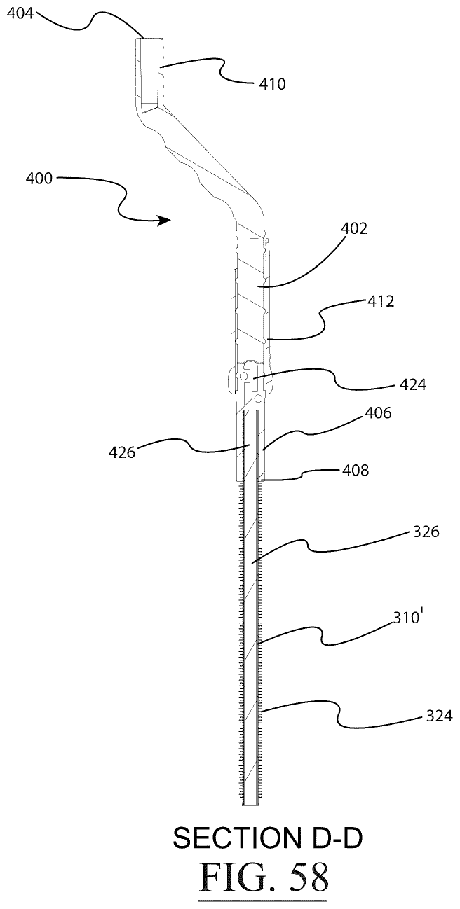

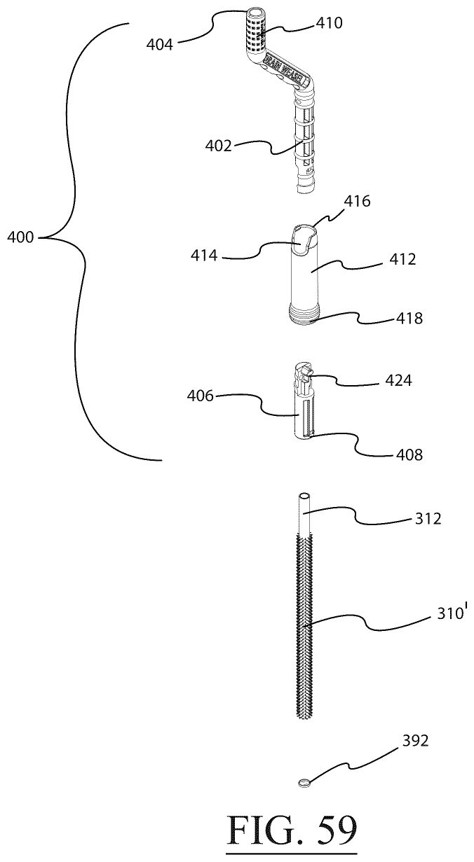

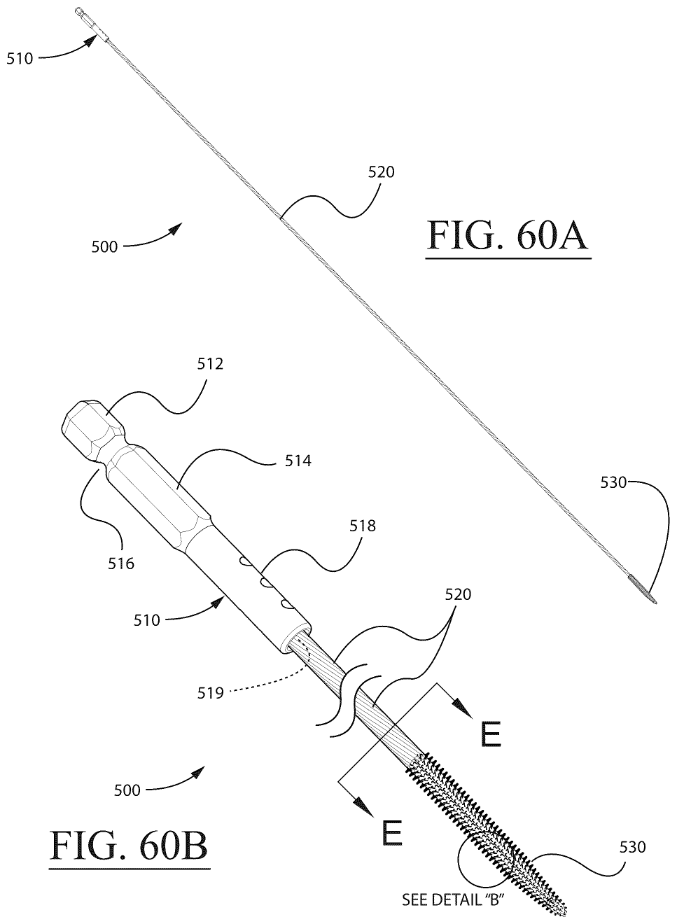

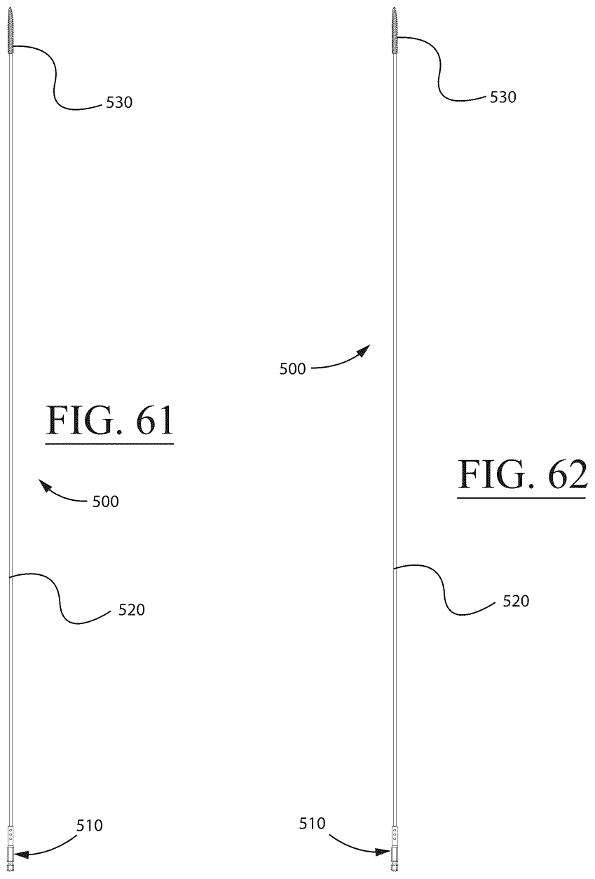

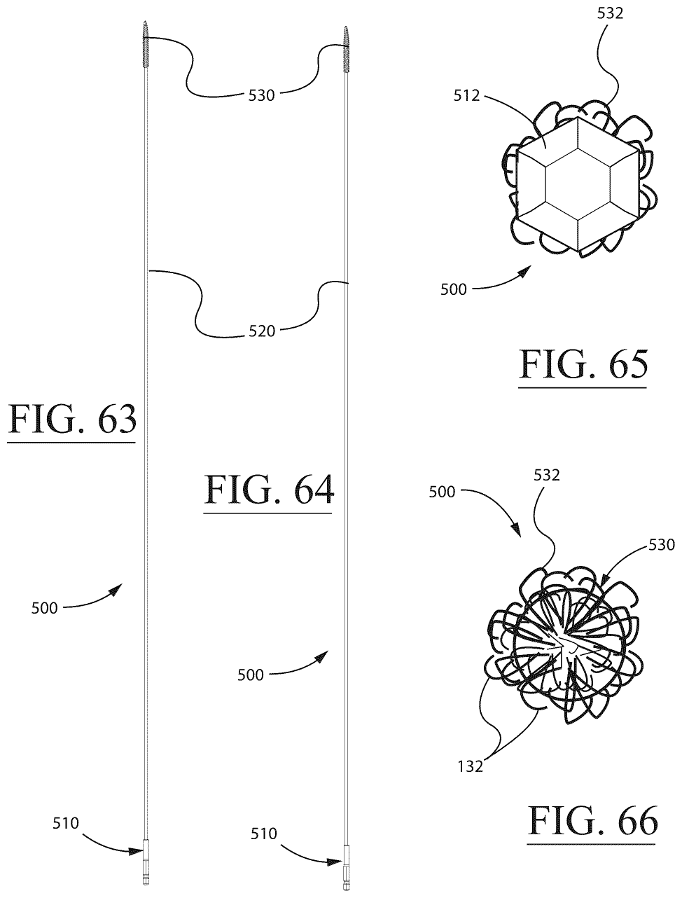

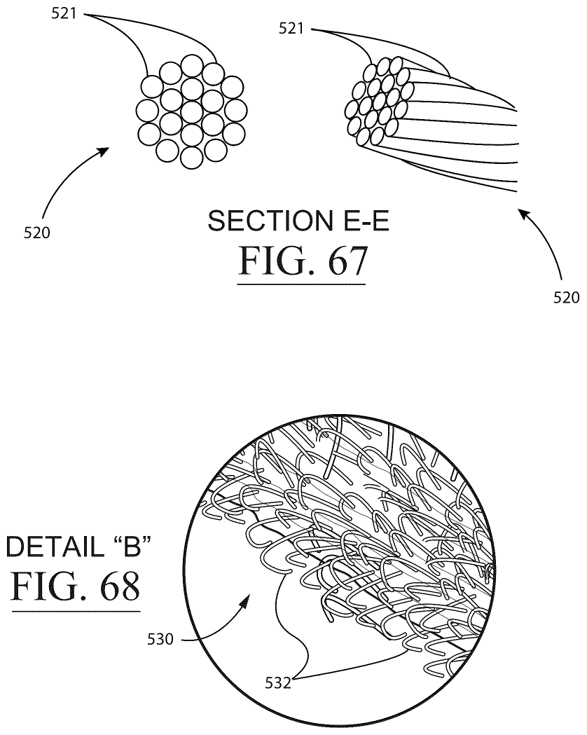

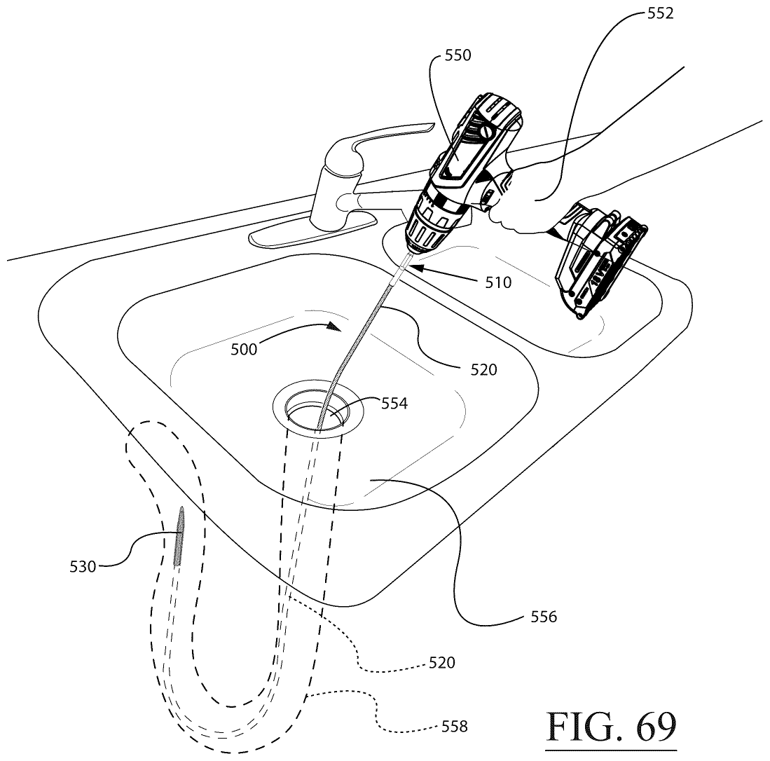

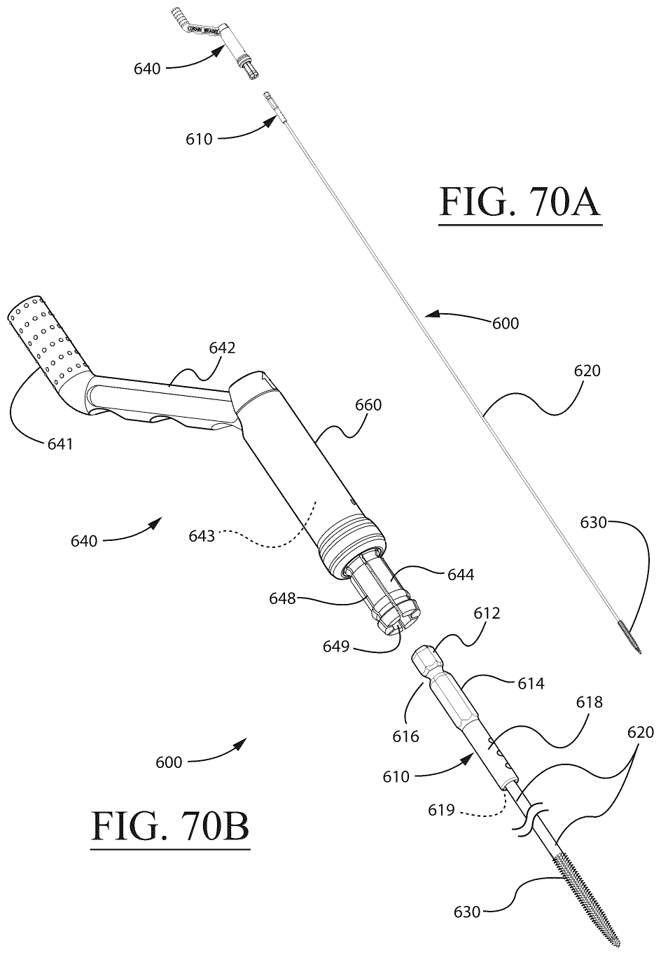

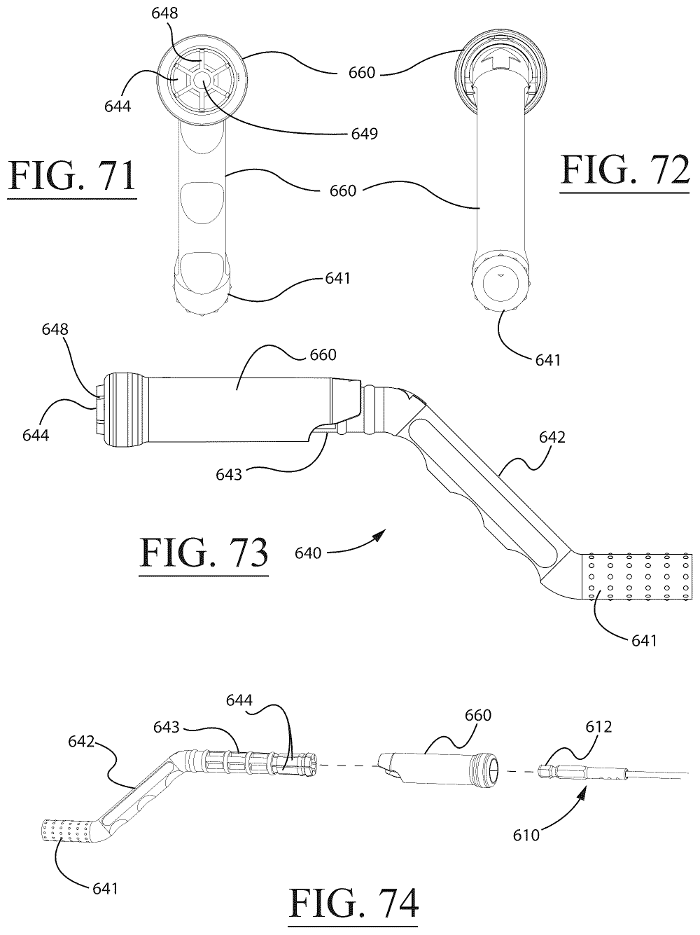

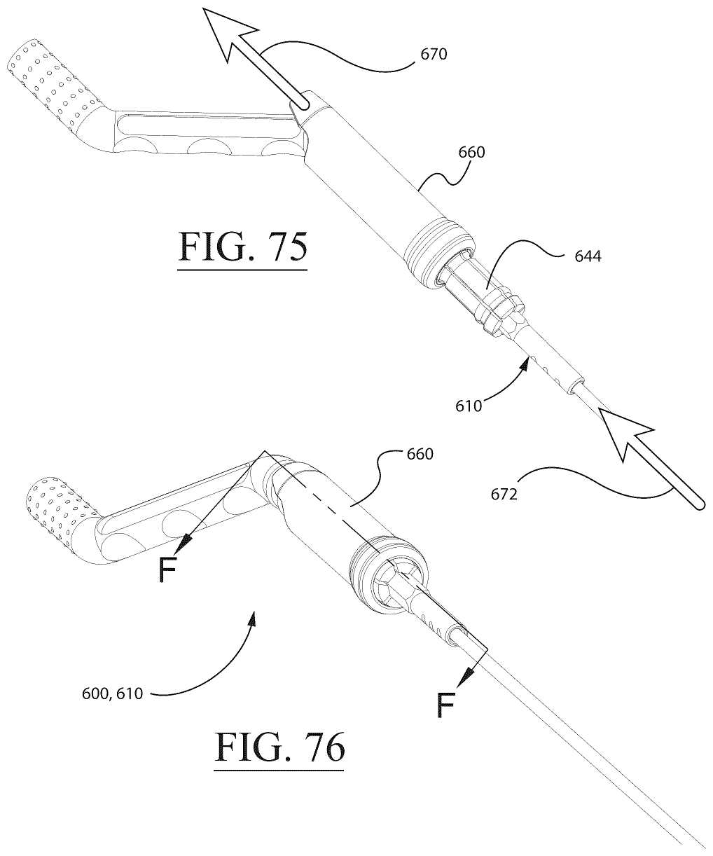

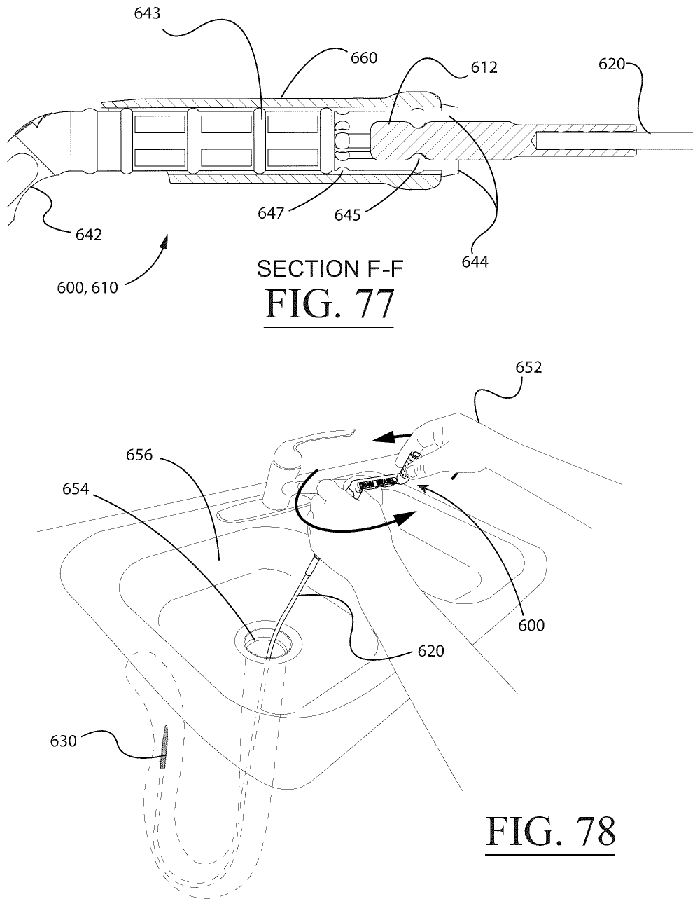

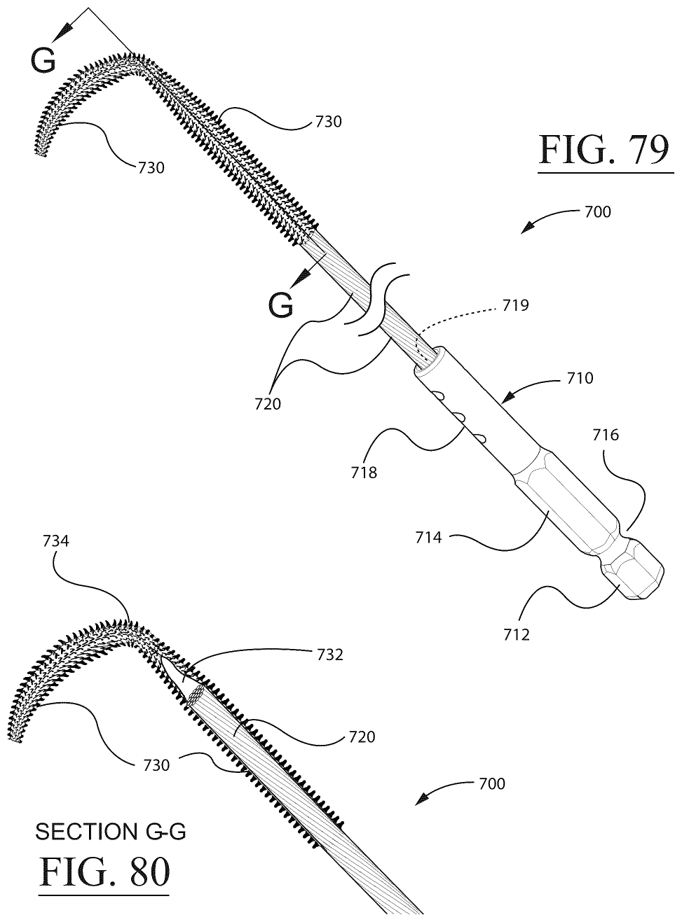

Similar to that described above for the first illustrative embodiment, the disposable drain cleaning device 240 of the second illustrative embodiment is attached to the power tool adapter 10 by engagement of the proximal end portion 242 (i.e., the end that is closest to the person when operating the device) of the drain cleaning device 240 fully engaging with the distal end portion 16 of the power tool adapter 10 (see FIG. 18). A slidable sleeve member 20 is shown in the engaged position and the drain cleaning device 240, as shown in FIG. 15, is in the fully engaged configuration. The sleeve member 20 in this engaged position ensures that the drain cleaning device 240 and power tool adapter 10 are fully engaged, i.e., interlocked at their corresponding ends, and the device is ready for use, such as for clearing a clogged drain pipe or for other similar pipe-cleaning functions.

In the second illustrative embodiment, with reference to FIGS. 15-17, it can be seen that the drain cleaning device 240 generally comprises an elongated rod section 244 or elongated shaft section 244 having a first end with connector section 243 and a second end with a tip section extending to a tip 246. The first end of the elongated rod section 244 is oppositely disposed relative to the second end of the elongated rod section 244. The elongated rod section 244 further includes the plurality of hook elements 248 projecting outwardly from the elongated rod section 244. In the illustrative embodiment, the plurality of hook elements 248 are disposed around a periphery of the elongated rod section 244 and along a length of the elongated rod section 244 between the first end and the second ends (see FIG. 15).

In the illustrative embodiment, the plurality of hook elements 248 on the elongated rod section 244 are in the form of a plurality of injection-molded micro-hook elements configured to grab and collect the hair and/or debris from the drain pipe being cleaned. In the illustrative embodiment, the plurality of injection-molded micro-hook elements may be in the form of inverted J-shaped projections and T-shaped projections protruding outwardly from the elongated body of the cleaning device 240. The plurality of injection-molded micro-hook elements may be disposed on opposite first and second sides of the elongated body of the cleaning device 240. The injection-molded micro-hook inverted J-shaped elements that are disposed on the first side and the second side of the elongated body of the cleaning device may be arranged in rows where every other injection-molded micro-hook element points in an opposite direction (i.e., the injection-molded micro-hook elements point in alternating directions along the length of the elongated body—see e.g., FIGS. 10-12 in U.S. Pat. No. 10,857,577, the entire disclosure of which is incorporated herein by reference).

In other embodiments, the elongated rod section further comprises a central core portion and an outer covering bonded to the central core portion. The outer covering is formed from a hook material strip, and the hook material strip comprises the plurality of hook elements of the elongated rod section. In these other embodiments, the hook material strip may be made from a hook side of a hook-and-loop fastener material (e.g., made from the hook portion of Velcro®—see e.g., FIGS. 5 and 9 of U.S. Pat. No. 10,857,577), rather than being injection-molded micro-hook elements.

Referring to FIGS. 15, 18, and 19, in the second illustrative embodiment, the drain cleaning device 240 further comprises an elongated sleeve member 250 rotatably disposed on a longitudinal portion of the elongated rod section 244. The elongated sleeve member 250 is configured to be grasped by a hand of a user during the spinning of the drain cleaning device 240 by the rotary motion input device (e.g., a drill 70) so as to help stabilize the drain cleaning device 240. The drain cleaning device is configured to be rotated relative to the elongated sleeve member 250 while the elongated sleeve member 250 is held stationary by the hand of the user (e.g., similar to the adapter sleeve member 20 described above). In the illustrative embodiment, the elongated sleeve member 250 may be formed from a piece of thin extruded plastic with a slit, or from a thin molded plastic sleeve. In the illustrative embodiment, the elongated rod section 244 may have a length that is approximately 30 inches, and the elongated sleeve member 250 may have a length that is approximately 8 inches.

In the illustrative embodiment, the drain cleaning device 240 is preferably disposable and can be made of any suitable disposable, recyclable or biodegradable material (e.g., a suitable plastic), such as polyethylene, polystyrene, polycarbonate, acrylic polymer, or nylon. The power tool adapter 10 is preferably reusable and can be made of a suitably durable material (e.g., a suitable plastic) to withstand repeated engagement and disengagement with drain cleaning devices 240 and repeated use.

Referring again to FIG. 18, in the second illustrative embodiment, rather than using the power tool adapter 10 with the drain cleaning device 240, the proximal end portion 242 of the disposable drain cleaning device 240 may be alternatively connected to the distal end portion 262 of a manual handle 260 that allows a user to manually rotate the drain cleaning device 240 without the use of a power tool. Advantageously, in the illustrative embodiment, the proximal end portion 242 of the disposable drain cleaning device 240 may be interchangeably connected with either the distal end portion 16 of the power tool adapter 10 or the distal end portion 262 of a manual handle 260 so that a user may select either powered or manual rotation of the drain cleaning device 240. Like the power tool adapter 10, the manual handle 260 is preferably reusable and can be made of a suitably durable material (e.g., a suitable plastic) to withstand repeated engagement and disengagement with drain cleaning devices 240 and repeated use. As shown in FIG. 18, the manual handle 260 includes an upper handle portion 264, a transverse handle portion 266, and a lower handle portion 268.

It is readily apparent that the aforedescribed power tool adapter 10 for a drain cleaning device offers numerous advantages. For example, the power tool adapter 10 enables a user to utilize the power of a power tool for rotating the drain cleaning device 40, 240 so as to clear sink and tub drain clogs, rather than having to manually manipulate the device 40, 240 by hand. As such, when powered by a drill or other similar rotary motion input device, the drain cleaning assembly 100, 200 effectively cleans a bathroom drain or other type of drain by unblocking the drain of accumulated hair and other debris. The drain cleaning assembly 100, 200 may be used for cleaning drains by removing hair and other debris that is collected in the upper portion of the drain where stopper or strainer mechanisms and other obstructions occur or collected anywhere along the drain pipe down to the bottom elbow bends of the drain where hair and other debris has collected (e.g., in the drain trap). In addition to saving users time and effort, the power tool adapter 10 described herein that is used in conjunction with the drain cleaning device 40, 240 provides the strength and mobility that some disabled users may need to do this common household task rather than calling in a professional.

A third illustrative embodiment of a cleaning device is seen generally at 310 in FIGS. 20-22 and 30. The cleaning device 310 is used for removing hair and/or debris from a rotary brush (e.g., from a vacuum roller brush) or a drain. With initial reference to FIG. 22, it can be seen that the cleaning device 310 generally comprises an elongated rod having a first end 312, a second end 314, and a rod axis, the first end 312 of the elongated rod being oppositely disposed relative to the second end 314 of the elongated rod, the elongated rod further including a plurality of protruding elements 324 projecting outwardly from the elongated rod, the plurality of protruding elements 324 being disposed at least partially around a periphery of the elongated rod and along at least a portion of a length of the elongated rod between the first end 312 and the second end 314. As shown in FIGS. 20 and 21, the first end 312 of the elongated rod is configured to be coupled to a rotary motion input device (e.g., a battery-powered drill 334) that is sufficient to rotate the plurality of protruding elements 324 of the elongated rod about the rod axis; and upon the elongated rod being rotated by the rotary motion input device (e.g., the drill 334), the plurality of protruding elements 324 are configured to grab and collect the hair and/or debris from a rotary brush so as to clean the rotary brush (e.g., a rotary brush 344 of a vacuum cleaner 342—see FIGS. 31 and 32).

As shown in FIGS. 20 and 21, in the third illustrative embodiment, the rotary cleaning system 340 comprises the cleaning device 310 and the drill 334. As such, in the third illustrative embodiment, the battery-powered drill 334 forms the rotary motion input device of the powered rotary cleaning system 340. In FIGS. 20 and 21, it can be seen that the first end 312 of the elongated rod of the cleaning device 310 is coupled to the chuck 336 of the battery-powered drill 334 so that the drill 334 rotates the elongated rod of the cleaning device 310 about the rod axis.

While a battery-powered drill 334 serves as the rotary motion input device for the rotary cleaning system 340 of the third illustrative embodiment, it is to be understood that various other rotary motion input devices may be used, such as a manual drill, a manual screwdriver, a power screwdriver, and a hand crank. For example, a manual rotary cleaning system 348 that utilizes a manual handle assembly 350 will be described hereinafter with regard to the fourth illustrative embodiment of the rotary cleaning system.

Now, with combined reference to FIGS. 22-24, additional features of the illustrative cleaning device 310 will be explained. As best shown in the end view of FIG. 24, the elongated rod of the cleaning device 310 further comprises a central core portion 316 and an outer covering 322 bonded to the central core portion 316. In the illustrative embodiment, the outer covering 322 is formed from a hook material strip. More specifically, in the illustrative embodiment, the hook material strip is made from a hook portion of a hook-and-loop fastener material (e.g., made from the hook portion of Velcro®). As such, in the illustrative embodiment, the hook elements of the hook material strip (e.g., the hook portion of Velcro®) form the plurality of protruding elements 324 of the elongated rod of the cleaning device 310.

Referring again to the end view of FIG. 24, it can be seen that, in the illustrative embodiment of FIGS. 20-24, the central core portion 316 of the cleaning device 310 is formed from a semi-flexible cable. In the illustrative embodiment, as best shown in FIG. 23, the semi-flexible cable 316 comprises a plurality of inner metal wires 318 surrounded by an outer plastic sheathing 320. In the illustrative embodiment, the hook material strip 322 is bonded to the outer plastic sheathing 320 of the semi-flexible cable 316 (e.g., the hook portion of Velcro® is glued onto the outer plastic sheathing 320 of the cable 316). As shown in FIG. 30, one or more ends 314 of the central core portion 316 of the cleaning device 310 may be terminated by soldering 332 the inner metal wires 318 of the central core portion 316 so as to avoid loose protruding wires, and to give a more finished appearance to the cleaning device 310.

In the illustrative embodiment of FIGS. 22-24, the semi-flexible cable, which is used for the central core portion 316 of the cleaning device 310, comprises plastic-coated aircraft cable with a 7/32 inch diameter and a 7×19 wire configuration (see FIG. 25). In other embodiments, other types of cable are used for the central core portion 316 of the cleaning device 310. For example, with reference to FIG. 26, the semi-flexible cable that is used for the central core portion 316 of the cleaning device 310 may have a different wire configuration 318′ (e.g., a 1×19 wire configuration). The wire configuration 318′ of FIG. 26 results in a stiffer wire core portion 316 with fewer strands of wires.

Next, with reference to the illustrative embodiment of FIGS. 27-29, a second type of central core portion that may be used in the cleaning device 310 will be described. Initially, as shown in FIG. 27, the central core portion of the cleaning device 310′ is formed from a plastic core 326, rather than the semi-flexible cable 316 described above. For example, the plastic core version of the cleaning device 310′ may be used for applications where a more rigid elongated rod is needed. Different types of plastic cores 326, 328 that may be used for the cleaning device 310′ are shown in FIG. 28. In the illustrative embodiments utilizing a plastic core, the hook material strip 322 is bonded to the outer periphery of the plastic core 326, 328 (e.g., the hook portion of Velcro® is glued onto the outer periphery of the plastic core 326, 328). As shown in FIG. 29, one or more ends 314 of the plastic core 326, 328 of the cleaning device 310′ may be terminated by dipping the end 314 of the cleaning device 310′ in glue or plastic 330 so as to avoid sharp edges, and to give a more finished appearance to the cleaning device 310′.

In the illustrative embodiments described above, the cleaning device 310, 310′ comprises a rotatable rod of proper diameter and flexibility, which is wrapped with an outer layer of the hook portion of woven, hook-and-loop fastener textile material. The cleaning sticks 310, 310′ are inserted into a rotational appliance such as a drill or plastic spinning handle, and when the sticks 310, 310′ are placed next to a vacuum cleaner roller brush and rotated, they quickly and conveniently clean off the hair and fibrous material that commonly accumulates on household vacuums.

In the illustrative embodiments described above, the cleaning device 310, 310′ uses the hook portion of a hook-and-loop textile fastener material (e.g., the hook portion of Velcro®), not as a fastener system, but in a unanticipated way as a cleaning element creating unexpected results, not by attaching the hook-and-loop fastener material flat to a surface as prescribed by the fastener system, but rather by wrapping the hook portion of a hook-and-loop textile fastener material into a tight circle onto a stiff rod, which creates a continuous hooking surface as it is rotated, with the hooks hitting the hair on the vacuum roller in a perpendicular orientation while spinning the rod with a rotating appliance, such as a drill or spinning handle. The micro-hooks of the hook-and-loop material spinning in a horizontal plane will hook the hair and fibers which are wrapped onto the vacuum roller in a vertical plane. This hooking action is similar to a grappling hook when it is thrown over a rope and pulled to capture the rope. The tough, thermoset monofilament nylon micro-hooks of the hook-and-loop material will hold onto the vacuum roller hair and thread debris just as securely as the hook portion holds onto its mated loop portion of the hook-and-loop material. As the cleaning stick 310, 310′ is rotated by a drill or hand crank handle, the “grappled” hair fibers are pulled and wrapped around the circumference of the stick 310, 310′ as the hair and/or thread fibers break, and are pulled off the vacuum roller. As the spinning cleaning stick 310, 310′ wraps the hair debris, it adds pull strength, which is similar to a tug of war participant when they wrap the rope around their arm in order to create more holding/pulling force and to prevent slippage.

In other embodiments, the plurality of protruding elements of the elongated rod of the cleaning device may comprise other suitable forms. For example, in other embodiments, the plurality of protruding elements of the elongated rod are in the form of a plurality of injection-molded micro-hook elements configured to grab and collect the hair and/or debris from the rotary brush being cleaned. In these other embodiments, the plurality of injection-molded micro-hook elements may be in the form of inverted J-shaped projections and T-shaped projections protruding outwardly from the elongated body of the cleaning device. The plurality of injection-molded micro-hook elements may be disposed on opposite first and second sides of the elongated body of the cleaning device. As one example, two rows of injection-molded micro-hook inverted J-shaped elements may be provided on each side of the elongated body of the cleaning device, while one row of injection-molded micro-hook T-shaped elements may be provided on each of the top and bottom of the elongated body of the cleaning device. Also, the injection-molded micro-hook inverted J-shaped elements that are disposed on the first side and the second side of the elongated body of the cleaning device may be arranged in rows where every other injection-molded micro-hook element points in an opposite direction (i.e., the injection-molded micro-hook elements point in alternating directions along the length of the elongated body). In addition, in these other embodiments, the injection-molded micro-hook inverted J-shaped elements that are disposed on the first side and the second side of the elongated body of the cleaning device may comprise two rows of micro-hook elements with free ends that point in generally opposite directions (e.g., refer to FIGS. 10-12 in U.S. Pat. No. 10,857,577, the entire disclosure of which is incorporated herein by reference).

A fourth illustrative embodiment of a rotary cleaning system is seen generally at 348 in FIGS. 33 and 34. As shown in these figures, in the fourth illustrative embodiment, the rotary cleaning system 348 comprises the cleaning device 310 and a first type of manual handle assembly 350. As such, in the fourth illustrative embodiment, a user manually turns the handle 352 of the handle assembly 350 to impart rotary motion to the cleaning device 310. In FIGS. 33 and 34, it can be seen that the first end 312 of the elongated rod of the cleaning device 310 is coupled to the mandrel 368 of the manual handle assembly 350 so that a user is able to pivot the elongated rod of the cleaning device 310 about the rod axis by rotating the handle 352.

Turning again to FIGS. 33 and 34, it can be seen that the illustrative manual handle assembly 350 generally comprises a handle collet subassembly 352, a sleeve 364, and a mandrel 368. The handle collet subassembly 352 of the manual handle assembly 350 is illustrated in further detail in FIGS. 35 and 36. As shown in these figures, the handle collet subassembly 352 comprises an upper handle portion 354 that is connected to a lower handle portion 360 by a connecting portion 356. In the illustrative embodiment, the upper and lower handle portions 354, 360 have central axes that are disposed generally parallel to one another, and the connecting portion 356 has a central axis that is disposed generally perpendicular to the upper handle portion 354 and the lower handle portion 360. Also, as shown in FIGS. 35 and 36, the connecting portion 356 or transverse handle portion 356 has a plurality of finger recesses 358 formed therein for accommodating the fingers of a user. The handle collet subassembly 352 further comprises a stick gripping portion 362 at the distal end of the lower handle portion 360.

A detail view of the sleeve 364 of the illustrative manual handle assembly 350 is shown in FIGS. 37 and 38. As shown in these figures, the sleeve 364 is provided with a central aperture 366 so as to allow the sleeve 364 to be slipped over the lower handle portion 360 of the handle collet subassembly 352. When the handle 352 is rotated by a user, the sleeve 364 is designed to be held stationary by one hand of the user such that the handle collet subassembly 352 rotates relative to the sleeve 364.

A detail view of the mandrel 368 of the illustrative manual handle assembly 350 is shown in FIGS. 39-41. As shown in these figures, the mandrel 368 is provided with a central aperture 370 so as to allow the mandrel 368 to be fitted onto the stick gripping portion 362 of the handle collet subassembly 352. Once the cleaning device 310 is inserted into the recess in the end of the stick gripping portion 362, the mandrel 368 is able to be tightened by a user so that the stick-like cleaning device 310 is securely held in place within the stick gripping portion 362 (i.e., the mandrel 368 operates as a tightening collar for the manual handle assembly 350).

Now, with reference to FIGS. 31 and 32, an illustrative cleaning application for the cleaning device 310, 310′ described above will be explained. As shown in FIGS. 31 and 32, the rotary brush 344 of the vacuum cleaner 342 contains hair and other debris 346 disposed therearound, which acts to undesirably impede the desired rotation of the rotary brush 344. In order to remove this hair and other debris 346 from the rotary brush 344 of the vacuum cleaner 342, a user initially inserts a cleaning device 310 into the chuck 336 of the battery-powered drill 334, and then tightens the jaws of the drill chuck 336 onto the cleaning device 310 using the tightening collar of the chuck 336. Then, the cleaning device 310 is inserted into the rotary brush 344 in close proximity to the hair and other debris 346, and the cleaning device 310 is rotated about its central axis by activating the drill 334. As the cleaning device 310 is rotated by the drill 334, the plurality of protruding elements 324 of the elongated rod of the cleaning device 310 engage with the hair and other debris 346 in the rotary brush 344 of the vacuum cleaner 342 so as to clean the rotary brush 344. As shown in FIGS. 31 and 32, after cleaning the rotary brush 344 of the vacuum cleaner 342, the cleaning device 310 collects hair and other debris 338′ on the distal end thereof.

A fifth illustrative embodiment of a rotary cleaning system is illustrated in FIGS. 42-50. As shown in these figures, in the fifth illustrative embodiment, the rotary cleaning system comprises the cleaning device 310′ described above and a power tool adapter 372. In this illustrative embodiment, the power tool adapter 372 may be reusable, and may be configured to couple the proximal end of the cleaning device 310′ to a rotary motion input device (e.g., a drill). Referring initially to FIGS. 42 and 50, it can be seen that the power tool adapter 372 includes an adapter body 374 with a shank section 382 for being inserted into a recess of the rotary motion input device (e.g., the drill 334 in FIG. 20). The cleaning device 310′ is attached to the power tool adapter 372 by engagement of the proximal end portion (i.e., the end that is closest to the person when operating the device) of the cleaning device 310′ being engaged with distal end portion of the power tool adapter 372. A slidable sleeve member 384 is shown in its fully engaged configuration in FIG. 42. The sleeve member 384 in this engaged position ensures that the cleaning device 310′and power tool adapter 372 are fully engaged, i.e., interlocked at their corresponding ends, and the device is ready for use, such as for cleaning a rotary brush of a vacuum cleaner.

In the illustrative embodiment, as shown in FIG. 42, the power tool adapter 372 generally comprises a body section 374 with a proximal end portion 376 and a connector section 378 with the distal end portion 380, the proximal end portion 376 of the body section 374 being oppositely disposed relative to the distal end portion 380 of the connector section 378. In FIG. 42, it can be seen that the distal end portion 380 of the connector section 378 is configured to be coupled to the proximal end portion of the cleaning device 310′. More specifically, as shown in the sectional view of FIG. 49, the connector section 378 is provided with a cylindrical bore 398 for receiving the proximal end portion of the cleaning device 310′ (e.g., the proximal end of the cleaning device 310′ may be affixedly secured in the cylindrical bore 398 by a suitable adhesive or glue). In the illustrative embodiment, the proximal end portion 376 of the adapter body section 374 is configured to be coupled to a rotary motion input device (e.g., a drill 334—see FIG. 20) that is sufficient to rotate the plurality of protruding elements 324 of the elongated rod of the cleaning device 310′ about the rod axis so as to grab and collect the hair and/or debris from a rotary vacuum brush so as to clean the rotary brush. As shown in FIG. 50, the distal end of the cleaning device 310′ may be provided with an end cap 392 to cover the exposed end of the elongated rod of the cleaning device 310′ (e.g., the end cap 392 may be glued on the distal end of the elongated rod of the cleaning device 310′).

In the illustrative embodiment, as shown in FIG. 42, it can be seen that the proximal end portion 376 of the adapter body 374 of the power tool adapter 372 comprises a shank section 382 for being inserted into a recess of the rotary motion input device (e.g., the drill 334 in FIG. 20). For example, the rotary motion input device for rotating the cleaning device 310′ may comprise a drill, a screwdriver, a power drill, or a power screwdriver. In the illustrative embodiment, the power tool adapter is configured for use with a drill, and the shank section at the proximal end portion of the adapter body is in a form of a drill bit shank section 382 for being inserted into a drill chuck recess. In the illustrative embodiment of FIG. 42, the drill bit shank section 382 has a generally hexagonal cross-sectional shape for being inserted into the drill chuck recess. In another embodiment, the drill bit shank section may have a generally circular cross-sectional shape for being inserted into the drill chuck recess.

In the illustrative embodiment, as will be described in further detail hereinafter, a user inserts the drill bit shank section 382 into a drill and tightens the chuck in the same fashion as using a drill bit. The slidable sleeve member 384 moves axially along the center of the power tool adapter between an engaged position (i.e., a locking position) and a disengaged position (i.e., a release position). This sliding action of the sleeve member 384 fully engages or releases the replaceable cleaning device 310′ and the connector section 378, which attaches to the distal end portion of the power tool adapter body 374. Once the drill bit shank section 382 of the power tool adapter is locked into the drill chuck, the user grasps the drill in one hand and the spinning sleeve member 384 with the other hand, and inserts the attached cleaning device 310′ into a rotary vacuum brush so as to clean hair and/or debris from the rotary brush. Then, the user simply runs the drill on slow speed and allows the drill to power the cleaning device 310′. The user can then detach the removable cleaning device 310′ and the connector section 378 of the cleaning device 310′ by sliding the spinning sleeve 384 of the power tool adapter up toward the proximal drill end (in the pointing direction of arrow 394 in FIG. 48), exposing the mated, interlocking ends of both the adapter body 374 and the connector section 378 attached to the cleaning device 310′ (see FIG. 50), thereby allowing for removal and replacement of the cleaning device 310′.

In the illustrative embodiment, the sleeve member 384 of the power tool adapter 372 can be moved back and forth between two possible positions along the adapter body 374: (i) a disengaged position where the connector section 378 attached to the cleaning device 310′ is able to be released from the power tool adapter 372, and (ii) an engaged position where the distal end portion of the adapter body 374 is locked into engagement with the connector section 378 attached to the cleaning device 310′. The sleeve member 384 of the power tool adapter has a proximal end 388 and a distal end 390 (see FIG. 50).

After use, the cleaning device 310′ and the attached connector section 378 are disengaged from the power tool adapter 372 (as described below) and can be discarded in an appropriate disposal receptacle, or in an appropriate recycling collection container.

In the illustrative embodiment, the sleeve member 384 of the power tool adapter has a generally cylindrical shape, but may include a notch 386 at its proximal end 388 (see FIG. 50). When the sleeve member 384 is moved backward to its disengaged position, the interlocking ends of the connector section 378 at the proximal end of the cleaning device 310′ and the distal end portion of the power tool adapter 372 are exposed and can be detached.

In the illustrative embodiment, the cleaning device 310′ and the attached connector section 378 are preferably disposable. The power tool adapter 372 is preferably reusable and can be made of a suitably durable material (e.g., a suitable plastic) to withstand repeated engagement and disengagement with the connector section 378 at the proximal end of the cleaning device 310′ and repeated use.

Now, with reference to the illustrative embodiment of FIGS. 42-50, the manner in which the cleaning device 310′ is attached to a driving power tool (e.g., a drill 334) will be explained. First of all, the drill bit shank section 382 of the power tool adapter 372 is inserted into the chuck of the battery-powered drill by a user, and then the user tightens the jaws of the drill chuck onto the drill bit shank section 382 of the power tool adapter 372 using the tightening collar of the chuck. Secondly, the user slides the sleeve member 384 of the power tool adapter 372 into its disengaged position. Then, the user engages the connector section 378 at the proximal end of the cleaning device 310′ with the distal end portion of the power tool adapter 372. More specifically, with reference to the illustrative embodiment of FIG. 49, the zigzag mating protrusion 396 of the connector section 378 is inserted into a corresponding recess in the distal end portion of power tool adapter body 374. Finally, once the connector section 378 at the proximal end of the cleaning device 310′ is engaged with the distal end portion of the power tool adapter 372, the user slides the sleeve member 384 into its engaged position so as to secure the connector section 378 at the proximal end of the cleaning device 310′ to the power tool adapter 372.

When the cleaning device 310′ is in the fully engaged configuration, the cleaning device 310′ is ready for use. The cleaning device 310′ can be inserted into a rotary vacuum brush to clean the hair and/or other debris therefrom. The user then places one hand on the sleeve member 384 of the power tool adapter 372 and uses the other hand to hold the drill. Pressing the trigger on the drill causes the cleaning device 310′ to rotate inside the clogged rotary vacuum brush, thereby removing obstructing materials. The power tool adapter 372 can be turned indefinitely to rotate the cleaning device 310′, thereby continuously collecting debris at the distal end of the cleaning device 310′.

A sixth illustrative embodiment of a rotary cleaning system is illustrated in FIGS. 51-59. As shown in these figures, in the sixth illustrative embodiment, the rotary cleaning system comprises the cleaning device 310′ described above and a second type of manual handle assembly 400. As such, similar to the fourth illustrative embodiment described above, a user manually turns the handle section 410 of the handle assembly 400 to impart rotary motion to the cleaning device 310′. In this illustrative embodiment, the manual handle assembly 400 may be reusable, and may be configured to be coupled to the proximal end of the cleaning device 310′. Referring initially to FIGS. 51 and 59, it can be seen that the manual handle assembly 400 includes a handle body 402 with a handle section 410 for being manually rotated by a user. The cleaning device 310′ is attached to the manual handle assembly 400 by engagement of the proximal end portion (i.e., the end that is closest to the person when operating the device) of the cleaning device 310′ being engaged with distal end portion of the handle assembly 400. A slidable sleeve member 412 is shown in its fully engaged configuration in FIG. 51. The sleeve member 412 in this engaged position ensures that the cleaning device 310′and the handle assembly 400 are fully engaged, i.e., interlocked at their corresponding ends, and the device is ready for use, such as for cleaning a rotary brush of a vacuum cleaner.

In the illustrative embodiment, as shown in FIG. 51, the manual handle assembly 400 generally comprises a handle body 402 with a proximal end portion 404 and a connector section 406 with the distal end portion 408, the proximal end portion 404 of the handle body 402 being oppositely disposed relative to the distal end portion 408 of the connector section 406. In FIG. 51, it can be seen that the distal end portion 408 of the connector section 406 is configured to be coupled to the proximal end portion of the cleaning device 310′. More specifically, as shown in the sectional view of FIG. 58, the connector section 406 is provided with a cylindrical bore 426 for receiving the proximal end portion of the cleaning device 310′ (e.g., the proximal end of the cleaning device 310′ may be affixedly secured in the cylindrical bore 426 by a suitable adhesive or glue). In the illustrative embodiment, the proximal end portion 404 of the manual handle assembly 400 is configured to be grasped and rotated by a user in order to rotate the plurality of protruding elements 324 of the elongated rod of the cleaning device 310′ about the rod axis, thereby grabbing and collecting the hair and/or debris from a rotary vacuum brush so as to clean the rotary brush. As shown in FIG. 59, the distal end of the cleaning device 310′ may be provided with an end cap 392 to cover the exposed end of the elongated rod of the cleaning device 310′ (e.g., the end cap 392 may be glued on the distal end of the elongated rod of the cleaning device 310′).

In the illustrative embodiment, as shown in FIG. 51, it can be seen that the handle body 402 of the manual handle assembly 400 generally comprises a top cylindrical handle portion 410 and a diagonal middle portion that comprises a plurality of finger concave recesses or indentations for accommodating fingers of the user when the cleaning device 310′ is being inserted into, and removed from a rotary vacuum brush (e.g., the handle body 402 of the manual handle assembly 400 may be similar to the handle section 402 in FIGS. 19-26 of U.S. Pat. No. 12,209,400, the entire disclosure of which is incorporated herein by reference).

In the illustrative embodiment, the slidable sleeve member 412 moves axially along the center of the manual handle assembly 400 between an engaged position (i.e., a locking position) and a disengaged position (i.e., a release position). This sliding action of the sleeve member 412 fully engages or releases the replaceable cleaning device 310′ and the connector section 406, which attaches to the distal end portion of the manual handle assembly 400. When performing a cleaning operation, the user grasps the handle portion 410 in one hand and the spinning sleeve member 412 with the other hand, and inserts the attached cleaning device 310′ into a rotary vacuum brush so as to clean hair and/or debris from the rotary brush. The user can then detach the removable cleaning device 310′ and the connector section 406 of the cleaning device 310′ by sliding the sleeve member 412 of the manual handle assembly 400 up toward the proximal handle end (in the pointing direction of arrow 422 in FIG. 57), exposing the mated, interlocking ends of both the handle body 402 and the connector section 406 attached to the cleaning device 310′ (see FIG. 59), thereby allowing for removal and replacement of the cleaning device 310′.

In the illustrative embodiment, the sleeve member 412 of the manual handle assembly 400 can be moved back and forth between two possible positions along the handle body 402: (i) a disengaged position where the connector section 406 attached to the cleaning device 310′ is able to be released from the manual handle assembly 400, and (ii) an engaged position where the distal end portion of the handle body 402 is locked into engagement with the connector section 406 attached to the cleaning device 310′. The sleeve member 412 of the manual handle assembly 400 has a proximal end 416 and a distal end 418.

After use, the cleaning device 310′ and the attached connector section 406 are disengaged from the manual handle assembly 400 (as described below) and can be discarded in an appropriate disposal receptacle, or in an appropriate recycling collection container.

In the illustrative embodiment, the sleeve member 412 of the manual handle assembly 400 has a generally cylindrical shape, but may include a notch 414 at its proximal end 416 (sec FIG. 59). When the sleeve member 412 is moved backward to its disengaged position, the interlocking ends of the connector section 406 at the proximal end of the cleaning device 310′ and the distal end portion of the manual handle assembly 400 are exposed and can be detached.

In the illustrative embodiment, the cleaning device 310′ and the attached connector section 406 are preferably disposable. The manual handle assembly 400 is preferably reusable and can be made of a suitably durable material (e.g., a suitable plastic) to withstand repeated engagement and disengagement with the connector section 406 at the proximal end of the cleaning device 310′ and repeated use.

Now, with reference to the illustrative embodiment of FIGS. 51-59, the manner in which the cleaning device 310′ is attached to the manual handle assembly 400 will be explained. First of all, the user slides the sleeve member 412 of the manual handle assembly 400 into its disengaged position (by sliding the sleeve member 412 in the pointing direction of arrow 422 in FIG. 57). Then, the user engages the connector section 406 at the proximal end of the cleaning device 310′ with the distal end portion of the handle body 402 of the manual handle assembly 400. More specifically, with reference to the illustrative embodiment of FIGS. 58 and 59, the zigzag mating protrusion 424 of the connector section 406 is inserted into a corresponding recess in the distal end portion of the handle body 402. Finally, once the connector section 406 at the proximal end of the cleaning device 310′ is engaged with the distal end portion of the handle body 402 of the manual handle assembly 400, the user slides the sleeve member 412 into its engaged position (by sliding the sleeve member 412 in the pointing direction of arrow 420 in FIG. 57) so as to secure the connector section 406 at the proximal end of the cleaning device 310′ to the manual handle assembly 400.

When the cleaning device 310′ is in the fully engaged configuration, the cleaning device 310′ is ready for use. The cleaning device 310′ can be inserted into a rotary vacuum brush to clean the hair and/or other debris therefrom. The user then places one hand on the sleeve member 412 of the manual handle assembly 400 and uses the other hand to rotate the cleaning device 310′ using the handle portion 410. The manual handle assembly 400 can be turned indefinitely to rotate the cleaning device 310′, thereby continuously collecting debris at the distal end of the cleaning device 310′.

In the illustrative embodiment, the cleaning device 310, 310′ is configured to be discarded after being used to remove the hair and/or debris from the rotary brush. For example, as shown in FIG. 21, a plurality of cleaning devices 310 may be provided in a multipack so that a used one of the cleaning devices 310 may be swapped out with a new, unused cleaning device 310 (e.g., the used cleaning device 310 of FIG. 21 in the drill 334 with hair and other debris 338 thereon may be removed from the drill 334, and replaced with one of the unused cleaning devices 310 lying next to the drill 334 in FIG. 21).

In one or more embodiments, the cleaning device 310, 310′ may be configured to be flipped end-for-end and reused after being used to remove the hair and/or debris from the rotary brush (e.g., from the rotary brush 344 of the vacuum cleaner 342 in FIGS. 31 and 32). Also, in one or more embodiments, the cleaning device 310, 310′ may be configured to be trimmed and reused after being used to remove the hair and/or debris from the rotary brush (e.g., from the rotary brush 344 of the vacuum cleaner 342 in FIGS. 31 and 32).

It is readily apparent that the aforedescribed cleaning device 310, 310′ offers numerous advantages. For example, cleaning device 310, 310′ is able to easily and safely remove hair and/or debris from a rotary brush, such as a vacuum roller brush.

As described above, an entirely unexpected result is produced when the hook portion of a hook-and-loop fastener material (e.g., the hook portion of Velcro®) is combined with a rotational appliance (e.g., a drill or manual handle) so as to produce an entirely new and effective vacuum roller cleaner. When hair and other debris is wrapped and attached around the tight diameter of the properly-sized roller cleaning stick 310, 310′ a grappling force is created that is stronger than the strength of the wrapped hair and carpet thread debris, thereby allowing the cleaning sticks 310, 310′ to grapple, break and wrap the debris in a fast, continuous fluid circular motion so as to create a new, faster, safer, and more effective tool and method for cleaning a rotary brush (e.g., a vacuum roller brush).

A seventh illustrative embodiment of a drain cleaning device is seen generally at 500 in FIGS. 60A-69. FIG. 60A shows a perspective view of the illustrative drain cleaning device 500 that includes an elongated shaft 520 having a first end, a second end, and a shaft axis, the first end of the elongated shaft 520 being oppositely disposed relative to the second end of the elongated shaft 520, the elongated shaft 520 further including a plurality of protruding elements projecting outwardly from the elongated shaft 520, the plurality of protruding elements being disposed around a periphery of the elongated shaft 520 at the distal end of the elongated shaft 520. The first end of the elongated shaft 520 is configured to be coupled to a rotary motion input device (e.g., a drill or detachable handle section) that is sufficient to rotate the plurality of protruding elements of the elongated shaft 520 about the shaft axis whereby, upon the elongated shaft 520 being rotated by the rotary motion input device, the plurality of protruding elements are configured to grab and collect debris from a drain pipe.

With combined reference to FIGS. 60A and 60B, it can be seen that the drain cleaning device 500 includes a power tool adapter 510. In the illustrative embodiment, the power tool adapter 510 comprises a drill adapter with a hex-shaped end portion (i.e., a shank section) that goes into the user-provided drill. The drill adapter may be machined or cast from a metal, such as aluminum. For example, the drill adapter may be machined from aluminum and non-anodized. Alternatively, rather than using aluminum, the drill adapter could alternatively be made from a tough plastic, such as polycarbonate or nylon. As shown in FIG. 60B, in the illustrative embodiment, the drill adapter 510 has a cylindrical hole 519 in the bottom thereof where the elongated shaft 520 is inserted. As will be described hereinafter, the elongated shaft 520 (e.g., the snake body) may be formed from multi-strand wire.

Referring to the enlarged view of FIG. 60B, it can be seen that the power tool adapter 510 comprises a first hex-shaped end portion 512 configured to be inserted into a drill chuck recess, an annular recess 516, a second hex-shaped portion 514, and circular hollow shaft portion 518 with the cylindrical hole 519 formed therein. In an example embodiment, the power tool adapter 510 has an overall length of approximately 55.4 millimeters (mm) and the circular hollow shaft portion 518 of the power tool adapter 510 has an overall length of approximately 30.0 millimeters (mm).

In the illustrative embodiment, referring to FIG. 67, the elongated shaft 520 may be formed from a multi-strand, braided wire (e.g., aviation wire or wire rope). The stiffness of the multi-strand wire is dependent upon the makeup of the stranded wires. There are many types of wire rope, but in one illustrative embodiment, the multi-strand wire is a 7×7 construction (seven (7) bundles of wire 521 of seven (7) wires each wound in either a RHL right hand direction or a LHL (left hand lay) direction. In the illustrative embodiment, the multi-strand wire will be a 7×7 galvanized wire with no plastic coating (to reduce diameter for access to drains with tight stoppers). The multi-strand wire may also in other embodiments be plastic coated to encapsulate the stranded wires and provide additional stiffness and wire protection.

In the illustrative embodiment, referring to the detail in FIG. 68, the plurality of protruding elements at the tip of the drain cleaning device 500 may comprise a hook material strip 530 (e.g., a fabric covering made from the hook portion of Velcro®). Advantageously, the micro-hook tip of the illustrative embodiment formed by the fabric material with myriads of formed hooks 532 (sec FIG. 68) is ideal for grappling drain hair and similar fibrous material when the snake is rotated. Alternatively, rather than the hook material strip, the tip of the drain cleaning device 500 could have barbs, a spring, or other grabbing means.

In the illustrative embodiment, during manufacturing, the 7×7 wire cable or rope forming the elongated shaft 520 is cut to length, inserted into the hole 519 in the aluminum drill adapter 510 and then swaged, crimped, or pressed onto the proximal end of the wire cable. In the illustrative embodiment, because LHL (left hand lay) wire cable is used, the drill 550 (sec FIG. 69) is ideally run only in a forward direction (i.e. in a direction that would “tighten” the strands rather than “unwind” the strands in the event the snake gets stuck and the user continues to run the drill—similar to spring auger tools directions to run in forward direction to avoid cable damage). Alternatively, a 7×19 wire cable may form the elongated shaft 520. Advantageously, because the wire cable has the feature of wanting to uncoil or spring back like a spring versus staying bent like a single wire snake, the wire cable more easily makes pipe bends than a single wire. The shaft could also be a spring. Advantageously, the wire cable is very strong and flexible in a small diameter to fit down a drain without taking the stopper apart. In the illustrative embodiment, the wire cable forming the elongated shaft 520 may have an approximately ⅛″ outside diameter.

In FIG. 69, an exemplary operation of the drain cleaning device 500 is illustrated. More specifically, FIG. 69 shows the inventive drain cleaning assembly 500 being used in a sink 556 to remove clogging debris from the drain pipe 558 of the sink 556. The sink 556 has an associated faucet for dispensing water into the sink 556. In the illustrative embodiment, the diameter of the elongated shaft 520 of the device 500 is sufficiently narrow to be easily inserted through openings in a typical drain cover all the way to the drain trap, often found in older residential bathrooms or modern drains having pop-up stoppers. Referring again to FIG. 69, after insertion of the elongated shaft 520 into the drain 554, the drain cleaning device 500 is rotated by the drill 550 held by a hand 552 of the user, thus winding into and capturing the clogging debris. The particular construction of the hook elements on the fabric tip section 530 allows the debris to be collected and grabbed by the drain cleaning device 500. After grabbing the clogging debris, the device 500 is removed from the drain 554.

In the illustrative embodiment, a user may insert the elongated shaft 520 of the device 500 into the drain 554 by hand until a pipe bend or obstruction is encountered. Then, the drill 550 is used in a slow to medium speed to spin the elongated shaft 520 of the device 500, which helps “walk” the fabric tip section 530 of the elongated shaft 520 around pipe bends or else winds the tip 530 into the encountered clog for retrieval. While running the drill 550 with one hand, the user may grasp the excess shaft body (glove suggested but not necessary) and provide pressure to push the tip 530 further down the drain 554 or engage the clog. If the device 500 gets “stuck” (i.e. going down one side of the stopper versus the other side) or does not want to advance, the user can withdraw the device 500 and make additional attempts in the same fashion.

In the illustrative embodiment, the drill 550 is used secondarily for its easy rotational ability when needed, but otherwise the device 500 is inserted into the drain and pushed forward with the user's free hand in a manual fashion. Advantageously, in the illustrative embodiment, the elongated shaft 520 of the device 500 is sufficiently thin and flexible so as to have the ability to fit past drain stoppers without drain disassembly, but still have enough stiffness such that the free hand of the user can push it further down the drain.

Advantageously, the drain cleaning device 500 fulfills a need in the market for a mid-range length do-it-yourself (DIY) tool that is not a cumbersome auger and does not require drain disassembly like most augers with ¼″ or larger diameter spring snake bodies.

In the illustrative embodiment, the drain cleaning device 500 may also be rotated using a detachable handle section instead of a drill 550. The detachable handle section will be described in detail in conjunction with the eighth embodiment hereinafter. The detachable handle section may allow the insertion of the same adapter end 510 into the bottom thereof, and the handle may include a sleeve that snaps down over the inserted hex drill adapter end of the device 500 locking the inserted hex drill head into place and allowing the user to manually crank the device 500. In the illustrative embodiment, the user will have to feed the elongated shaft 520 into the drain then pick up the handle and use both hands to hold and spin the elongated shaft 520 of the device 500. In the illustrative embodiment, the detachable handle section is formed from plastic. In other embodiments, the detachable handle section may be formed from metal, such as aluminum.

In the illustrative embodiment, the drain cleaning device 500 comprises a multi-strand wire shaft 520 (in a non-typical LHL direction) with a longer length (e.g., 36 inches, approximately 36 inches, or longer than 36 inches) and crimped drill adapter 510, does not typically require drain disassembly, allows the interchangeable use of a drill or a handle for producing rotary motion, and uses an effective micro-hook tip. In an alternative embodiment, the multi-strand wire shaft 520 could have a length longer than 36 inches.

In alternative embodiments, the drain cleaning device 500 could include removable tips by using a collet-like (e.g., Dremel) tip holder which is swaged onto the wire rope and allows various types of tips to be utilized or else simply being able to dispose of a removable hook material instead of an entire wand.

An eighth illustrative embodiment of a drain cleaning device is seen generally at 600 in FIGS. 70A-78. Referring to these figures, it can be seen that, in many respects, the illustrative embodiment of FIGS. 70A-78 is similar to that of the illustrative embodiment of FIGS. 60A-69. Moreover, many elements are common to both such embodiments. For the sake of brevity, the elements that the illustrative embodiment of FIGS. 70A-78 has in common with the embodiment of FIGS. 60A-69 will not be discussed in detail because these components have already been described above.

Similar to that described above for the seventh illustrative embodiment, the drain cleaning device 600 includes an elongated shaft 620 having a first end, a second end, and a shaft axis, the first end of the elongated shaft 620 being oppositely disposed relative to the second end of the elongated shaft 620, the elongated shaft 620 further including a plurality of protruding elements projecting outwardly from the elongated shaft 620, the plurality of protruding elements being disposed around a periphery of the elongated shaft 620 at the distal end of the elongated shaft 620. The first end of the elongated shaft 620 is configured to be coupled to a rotary motion input device (e.g., a drill or detachable handle section) that is sufficient to rotate the plurality of protruding elements of the elongated shaft 620 about the shaft axis whereby, upon the elongated shaft 620 being rotated by the rotary motion input device, the plurality of protruding elements are configured to grab and collect debris from a drain pipe.

In the eighth illustrative embodiment, similar to the seventh illustrative embodiment described above, the plurality of protruding elements at the tip of the drain cleaning device 600 may comprise a hook material strip 630 (e.g., a fabric covering made from the hook portion of Velcro®). Advantageously, the micro-hook tip of the illustrative embodiment formed by the fabric material with myriads of formed hooks is ideal for grappling drain hair and similar fibrous material when the snake is rotated. Alternatively, rather than the hook material strip, the tip of the drain cleaning device 600 could have injection-molded micro-hooks, barbs, a spring, or other grabbing means.

Referring to the enlarged view of FIG. 70B, similar to the seventh illustrative embodiment described above, it can be seen that the power tool adapter 610 comprises a first hex-shaped end portion 612 configured to be inserted into a handle recess or a drill chuck recess, an annular recess 616, a second hex-shaped portion 614, and circular hollow shaft portion 618 with the cylindrical hole 619 formed therein. In an example embodiment, the power tool adapter 610 has an overall length of approximately 55.4 millimeters (mm) and the circular hollow shaft portion 618 of the power tool adapter 610 has an overall length of approximately 30.0 millimeters (mm).

However, unlike the seventh illustrative embodiment described above, the elongated shaft 620 of the drain cleaning device 600 is in a form of a plastic shaft, rather than the wire cable shaft of the seventh illustrative embodiment.

Referring to FIGS. 70A-77, in the eighth illustrative embodiment, rather than being connected to a drill, the hex-shaped end portion 612 of the power tool adapter 610 of the drain cleaning device 600 may be alternatively connected to the distal end portion of a detachable handle section 640. The detachable handle section 640 allows a user to manually rotate the drain cleaning device 600 without the use of a power tool. Advantageously, in the illustrative embodiment, the hex-shaped end portion 612 of the power tool adapter 610 of the drain cleaning device 600 may be interchangeably connected with either a drill or the distal end portion of the detachable handle section 640 so that a user may select either powered or manual rotation of the drain cleaning device 600.

Referring initially to FIG. 70B, it can be seen that the detachable handle section 640 includes a handle body with a handle section 641 for being manually rotated by a user. The drain cleaning device 600 is attached to the detachable handle section 640 by engagement of the proximal end portion (i.e., the end that is closest to the person when operating the device) of the drain cleaning device 600 being engaged with distal end portion of the detachable handle section 640. A slidable sleeve member 660 is shown in its fully engaged configuration in FIG. 76. The sleeve member 660 in this engaged position ensures that the drain cleaning device 600 and the detachable handle section 640 are fully engaged, i.e., interlocked at their corresponding ends, and the device is ready for use, such as for cleaning a drain.

In the illustrative embodiment, referring to the sectional view of FIG. 77, it can be seen that the distal end portion of the detachable handle section 640 comprises a plurality of split arms 644 for grabbing the hex-shaped end portion 612 of the power tool adapter 610 of the drain cleaning device 600. More specifically, as shown in the sectional view of FIG. 77, the hex-shaped end portion 612 of the power tool adapter 610 is configured to be received within a circular recess 649 in the distal end portion of the detachable handle section 640 that is surrounded by the plurality of split arms 644. The split arms 644 are circumferentially arranged and spaced apart from each other by gaps 648 (see FIG. 70B). In the illustrative embodiment, each of the split arms 644 comprises a rounded protrusion 645 that is configured to be received within the annular recess 616 of the power tool adapter 610. As described below, when the slidable sleeve member 660 is in its engaged position, the rounded protrusions 645 of the split arms 644 lock the hex-shaped end portion 612 of the drain cleaning device 600 into the circular recess 649 of the detachable handle section 640. Also, as shown in the sectional view of FIG. 77, each of the split arms 644 are provided with a thinned region 647 to create more flex in the arms 644. The insertion direction of the hex-shaped end portion 612 of the drain cleaning device 600 into the circular recess 649 of the detachable handle section 640 is diagrammatically represented by the arrow 672 in FIG. 75.

In the illustrative embodiment, as shown in FIG. 70B, it can be seen that the handle body of the detachable handle section 640 generally comprises a top cylindrical handle portion 641, bottom cylindrical handle portion 643 and a diagonal transverse middle portion 642 connecting portions 641, 643 that comprises a plurality of finger concave recesses or indentations for accommodating fingers of the user when the drain cleaning device 600 is being inserted into, and removed from a drain.

In the illustrative embodiment, the slidable sleeve member 660 moves axially along the center of the bottom cylindrical handle portion 643 of the detachable handle section 640 between an engaged position (i.e., a locking position) and a disengaged position (i.e., a release position). This sliding action of the sleeve member 660 fully engages or releases the drain cleaning device 600. When performing a drain cleaning operation (e.g., as illustrated in FIG. 78), the user grasps the handle portion 641 in one hand 552 and the spinning sleeve member 660 with the other hand, and rotates the drain cleaning device 600 to clean the debris in the drain. The user can then detach the removable drain cleaning device 600 by sliding the spinning sleeve 660 of the manual handle assembly 500 up toward the proximal handle end (in the pointing direction of arrow 670 in FIG. 75), exposing the split arms 644 of the detachable handle section 640 grabbing hex-shaped end portion 612 of the power tool adapter 610 of the drain cleaning device 600, thereby allowing for removal of the drain cleaning device 600 from the detachable handle section 640 (see FIG. 70B).

In the illustrative embodiment, the sleeve member 660 of the detachable handle section 640 can be moved back and forth between two possible positions along the handle body: (i) a disengaged position where the drain cleaning device 600 is able to be released from the detachable handle section 640, and (ii) an engaged position where the distal end portion of the detachable handle section 640 is locked into engagement with the drain cleaning device 600.

A ninth illustrative embodiment of a drain cleaning device is seen generally at 700 in FIGS. 79 and 80. Referring to these figures, it can be seen that, in many respects, the illustrative embodiment of FIGS. 79 and 80 is similar to that of the seventh and eighth illustrative embodiments described above. Moreover, many elements are common to both such embodiments. For the sake of brevity, the elements that the illustrative embodiment of FIGS. 79 and 80 has in common with the seventh and eighth illustrative embodiments will not be discussed in detail because these components have already been described above.

Similar to that described above for the seventh and eighth illustrative embodiments, the drain cleaning device 700 includes an elongated shaft 720 having a first end, a second end, and a shaft axis, the first end of the elongated shaft 720 being oppositely disposed relative to the second end of the elongated shaft 720, the elongated shaft 720 further including a plurality of protruding elements projecting outwardly from the elongated shaft 720, the plurality of protruding elements being disposed around a periphery of the elongated shaft 720 at the distal end of the elongated shaft 720. The first end of the elongated shaft 720 is configured to be coupled to a rotary motion input device (e.g., a drill or detachable handle section) that is sufficient to rotate the plurality of protruding elements of the elongated shaft 720 about the shaft axis whereby, upon the elongated shaft 720 being rotated by the rotary motion input device, the plurality of protruding elements are configured to grab and collect debris from a drain pipe.

In the ninth illustrative embodiment, similar to the seventh and eighth illustrative embodiments described above, the plurality of protruding elements at the tip of the drain cleaning device 700 may comprise a hook material strip 730 (e.g., a fabric covering made from the hook portion of Velcro®). Advantageously, the micro-hook tip of the illustrative embodiment formed by the fabric material with myriads of formed hooks is ideal for grappling drain hair and similar fibrous material when the snake is rotated. Alternatively, rather than the hook material strip, the tip of the drain cleaning device 700 could have injection-molded micro-hooks, barbs, a spring, or other grabbing means.

Referring to the enlarged view of FIG. 79, similar to the seventh and eighth illustrative embodiments described above, it can be seen that the power tool adapter 710 comprises a first hex-shaped end portion 712 configured to be inserted into a drill chuck recess or handle recess, an annular recess 716, a second hex-shaped portion 714, and circular hollow shaft portion 718 with the cylindrical hole 719 formed therein. In an example embodiment, the power tool adapter 710 has an overall length of approximately 55.4 millimeters (mm) and the circular hollow shaft portion 718 of the power tool adapter 710 has an overall length of approximately 30.0 millimeters (mm).

However, unlike the seventh and eighth illustrative embodiments described above, the hook material strip 730 of the drain cleaning device 700 in FIGS. 79 and 80 has an extended length portion 734 (i.e., a flopped over end portion 734 with void 732 defined therein) that ends beyond the distal end of the elongated shaft 720 (e.g., the hook material strip 730 may extend approximately ½″ beyond the end of the wire cable of the drain cleaning device 700). Advantageously, the extended length portion of the hook material strip 730 that is unsupported by the elongated shaft 720 makes the end of the drain cleaning device 700 more flexible so that it jumps over obstructions in the drain and helps navigate bends easier.

It is readily apparent that the aforedescribed drain cleaning device 500, 600, 700 offers numerous advantages. For example, the ultra-slim design allows the drain cleaning device 500, 600, 700 to fit down tight drain openings. Using either the detachable handle or a power drill, the tiny micro hooks of the tip of the drain cleaning device 500, 600, 700 are spun 360 degrees, thus “locking” them into tough hair clogs. Advantageously, the two-hundred (200) or more micro-hooks of the illustrative drain cleaning device 500, 600, 700 do not get caught on drain parts. Also, advantageously, the drain cleaning device 500, 600, 700 is suitable for non-professional, do-it-yourself (DIY) users that do not want to use a cumbersome “auger” type drain snake but would like a lighter, easier to use, and cheaper device that is longer (e.g., 36 inches long) than typical inexpensive stick-like plastic devices that are available in the market.

Any of the features or attributes of the above described embodiments and variations can be used in combination with any of the other features and attributes of the above described embodiments and variations as desired.

Although the invention has been shown and described with respect to a certain embodiment or embodiments, it is apparent that this invention can be embodied in many different forms and that many other modifications and variations are possible without departing from the spirit and scope of this invention.

Moreover, while exemplary embodiments have been described herein, one of ordinary skill in the art will readily appreciate that the exemplary embodiments set forth above are merely illustrative in nature and should not be construed as to limit the claims in any manner. Rather, the scope of the invention is defined only by the appended claims and their equivalents, and not, by the preceding description.

The invention claimed is:

1. A drain cleaning device for removing debris from a drain, the drain cleaning device comprising:
an elongated shaft section having a first end, a second end, and a shaft axis, the first end of the elongated shaft section being oppositely disposed relative to the second end of the elongated shaft section; and
a tip section connected to the second end of the elongated shaft section, the tip section including a central core portion and a plurality of protruding elements extending from the central core portion, the plurality of protruding elements being disposed at least partially around a periphery of the central core portion;
wherein the first end of the elongated shaft section is configured to be coupled to a rotary motion input device that is sufficient to rotate the plurality of protruding elements of the tip section about the shaft axis; and
whereby, upon the elongated shaft section being rotated by the rotary motion input device, the plurality of protruding elements are configured to grab and collect debris from a drain pipe.

2. The drain cleaning device according to claim 1, wherein the rotary motion input device for rotating the elongated shaft section is selected from the group consisting of: (i) a drill, (ii) a screwdriver, (iii) a power drill, (iv) a power screwdriver, and (v) a detachable handle section.

3. The drain cleaning device according to claim 1, wherein the tip section further comprises an outer covering formed from a hook material strip that is bonded to the central core portion of the tip section that extends from the elongated shaft section, the hook material strip comprising the plurality of protruding elements of the tip section, and the hook material strip being made from a hook side of a hook-and-loop fastener material.

4. The drain cleaning device according to claim 3, wherein the elongated shaft section is formed from a semi-flexible cable, the semi-flexible cable comprising a plurality of bundled wires, the hook material strip being bonded to an outer surface of the semi-flexible cable.

5. The drain cleaning device according to claim 1, wherein the elongated shaft section comprises a plastic shaft.

6. The drain cleaning device according to claim 1, further comprising a power tool adapter configured to couple the first end of the elongated shaft section to the rotary motion input device, the power tool adapter includes an adapter body with a shank section for being inserted into a recess of the rotary motion input device.

7. The drain cleaning device according to claim 6, wherein the shank section of the power tool adapter has a generally hexagonal or round cross-sectional shape.

8. The drain cleaning device according to claim 6, wherein the shank section of the power tool adapter has an annular recess formed in the shank section.

9. The drain cleaning device according to claim 1, wherein the rotary motion input device is in a form of a detachable handle section configured to be detachably coupled to the elongated shaft section of the drain cleaning device.

10. The drain cleaning device according to claim 9, wherein the detachable handle section has a proximal end portion and a distal end portion, the distal end portion of the detachable handle section being configured to be detachably coupled to a proximal end portion of the elongated shaft section of the drain cleaning device.

11. The drain cleaning device according to claim 10, further comprising a sleeve member that is slidable along a length of the detachable handle section between (i) a disengaged position where the elongated shaft section of the drain cleaning device is able to be released from the detachable handle section, and (ii) an engaged position where the distal end portion of the detachable handle section is locked into engagement with the proximal end portion of the elongated shaft section of the drain cleaning device.

12. The drain cleaning device according to claim 11, wherein, in the engaged position of the sleeve member, the sleeve member is rotatably disposed about the detachable handle section, the sleeve member configured to be grasped by a hand of a user during the spinning of the drain cleaning device by the user so as to help stabilize the drain cleaning device, the drain cleaning device being configured to be rotated relative to the sleeve member while the sleeve member is held stationary by the hand of the user.

13. The drain cleaning device according to claim 9, wherein the detachable handle section comprises an upper handle portion and a lower handle portion, the upper handle portion being spaced apart from the lower handle portion along a length of the drain cleaning device, the upper handle portion configured to accommodate a first hand of a user during a spinning of the drain cleaning device by the user, and the lower handle portion configured to accommodate a second hand of the user during the spinning of the drain cleaning device by the user.

14. The drain cleaning device according to claim 13, wherein the detachable handle section further comprises a transverse handle portion connecting the upper handle portion to the lower handle portion.

15. The drain cleaning device according to claim 14, wherein at least one section of the upper handle portion or the lower handle portion has a generally circular cross-section.
